(19) United States
(12) Patent Application Publication
(10) Pub. No.: US 2011/0208730 A1
(43) Pub. Date: Aug. 25, 2011

(54) CONTEXT-AWARE SEARCHING

(75) Inventors: Daxin Jiang, Beijing (CN); Hang Li, Beijing (CN)

(73) Assignee: Microsoft Corporation, Redmond, WA (US)

(21) Appl. No.: 12/710,608

(22) Filed: Feb. 23, 2010

(51) Int. Cl. G06F 17/30

(52) U.S. Cl. 707/727; 707/738; 707/751; 707/E17.115; 707/E17.089; 707/780

(57) ABSTRACT

A model generated from search log data predicts a hidden state based on a query to determine a context of the query, such as for providing re-ranked search results, query suggestions and/or URL recommendations.

### BACKGROUND

Search engines provide technologies that enable users to search for information on the World Wide Web (WWW), databases, and other information repositories. Conventionally, the effectiveness of a user's information retrieval during a search largely depends on whether the user can submit effective queries to a search engine to cause the search engine to return results relevant to the intent of the user. However, forming an effective query can be difficult, in part because queries are typically expressed using a small number of words (e.g., one or two words on average), and also because many words can have a variety of different meanings, depending on the context in which the words are used. To make the problem even more complicated, different search engines may respond differently to the same query.

In addition, some search engines, such as those provided by the Google®, Yahoo!®, and Bing™ search websites, include features that assist users during a search. For example, based on various factors, a search engine may re-rank results, suggest a particular Uniform Resource Locator (URL), or suggest possible search queries. However, these features that are intended to assist the user often fail to produce results that coincide with the user's actual search intent.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide for context-aware searching by using a learned model to anticipate an intended context of a user's search based on one or more user inputs, such as for providing suggested queries, providing recommended results, and/or for re-ranking results already obtained.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 depicts an exemplary block diagram illustrating context-aware searching according to some implementations disclosed herein.

FIG. 2 illustrates a flow chart of an exemplary process for context-aware searching according to some implementations.

FIG. 3 illustrates a block diagram of an exemplary framework of context aware searching according to some implementations.

FIG. 4 illustrates an exemplary block diagram of a bipartite for determining states according to some implementations.

FIG. 5 illustrates an exemplary diagram of clustering according to some implementations.

FIG. 6 illustrates exemplary search session determination according to some implementations.

FIG. 7 illustrates a table of exemplary probabilities determined according to some implementations.

FIG. 8 illustrates an exemplary block diagram of a learned model according to some implementations.

FIG. 9 illustrates a flowchart of an exemplary offline process for determining a model according to some implementations.

FIG. 10 illustrates a flowchart of an exemplary online process for applying a model according to some implementations.

FIG. 11 illustrates an exemplary system according to some implementations.

FIG. 12 an exemplary server computing device according to some implementations.

FIG. 13 illustrates an exemplary computing device according to some implementations.

### DETAILED DESCRIPTION

### Context-Aware Searching

Some implementations herein provide for a context-aware approach to result re-ranking, query suggestion formation, and URL recommendation by capturing a context of a user's intent based on one or more inputs received from the user, such as queries and clicks (e.g., URL selections) made by the user during the search session. This context-aware approach of providing additional information based on an inferred context of the user can substantially improve a users' search experience by more quickly identifying and returning results that the user desires.

For example, suppose that a user wants to compare various different cars for a possible purchase. The user may decompose this general search task into several specific subtasks, such as by searching for cars provided by various different manufacturers by accessing each manufacturer's website sequentially. During each subtask, the user may have a particular search intent in mind and may formulate the query to describe the search intent. Moreover, the user may selectively click on some related URLs in the results to browse the contents thereof. Implementations herein provide a model in which each search intent is modeled as a state, and the submitted queries and clicked-on URLs are modeled as observations generated by the state. Consequently, the entire search process can be modeled as a sequence of transitions between states.

To capture the context of a user's search intent, inputs from the user may be applied to a learned model created based upon a large number of historical search logs. According to some implementations herein, when a user submits a current query qₜ during a search session, the context of the query qₜ can be captured based on one or more earlier queries or other inputs from the user in the same search session immediately prior to the current query qₜ. By applying the query qₜ to the learned model, the query qₜ is associated with multiple possible search intents using a probability distribution. Based on the probability distribution, the most likely search intent can be inferred, and then used to re-ranked search results received in response to the current query qₜ. Furthermore, the learned model is able to apply historical search data to the current search session to determine what queries other users often asked after a query similar to the current query qₜ in the same context. Those queries may then become candidates for suggesting a subsequent query qₜ₊₁ to the user.

In some implementations, the suggested subsequent query qₜ₊₁ can be modeled as a hidden variable, while the user's current qₜ and previous queries and URL clicks are treated as observed variables. Additionally, because the subsequent query qₜ₊₁ can be predicted from the model, it is also possible to predict subsequent search results and provide those predicted results to the user, such as for recommending a URL or result. Further, URLs or results that a user clicks on during the session may also be received as inputs and applied to the model as observed variables for aiding in making the predictions, suggestions, and the like. Consequently, according to implementations herein, a single model may be used for re-ranking results, providing URL recommendations and/or making query suggestions.

In some implementations, an example of the learned model may be a variable length Hidden Markov Model (vlHMM) generated from a large number of search sessions extracted from historical search log data. Implementations herein further provide techniques for learning a very large model, such as a vlHMM, with millions of states from hundreds of millions of search sessions using a distributed computation paradigm. The distributed computing paradigm implements a strategy for parameter initialization in model learning which, in practice, can greatly reduce the number of parameters estimated during creation of the model. The paradigm also implements a method for distributed model learning by distributing the processing of the search log data among a plurality of computing devices, such as by using a number of computational nodes controlled by one or more master nodes.

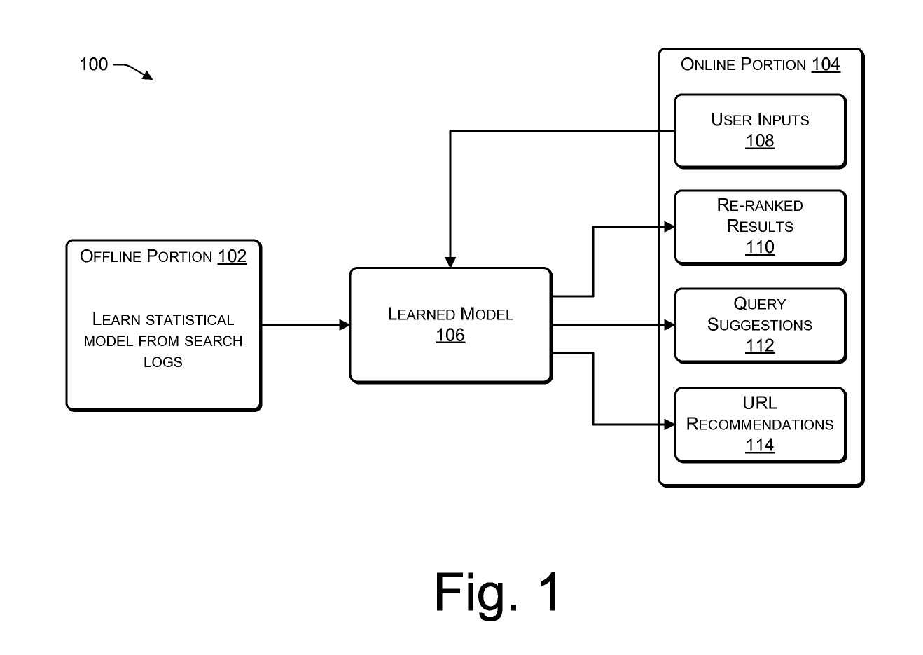

FIG. 1 illustrates an exemplary block diagram of a framework 100 for providing context-aware searching according to some implementations herein. The exemplary implementation of FIG. 1 includes an offline portion 102 and an online portion 104. During the offline portion, a learned model 106 is generated based on data extracted from a large number of historical search logs. For example, according to some implementations, during the offline portion, search logs (e.g., historical data providing past user queries and corresponding selected URLs) are accessed, and a data structure, such as a click-through bipartite graph, may be constructed to correlate queries with click-through URL's. As the name suggests, click-through URLs are URLs that the users actually clicked on (e.g., by clicking on the respective URL link in a set of search results) or otherwise selected following a specific query, as opposed to URLs that may have been returned in response to a search query, but that the users never selected. Implementations herein may also create query sessions from the search logs, which can assist in determining common contexts from the search data. Furthermore, patterns from the click-through bipartite may be mined to determine one or more concepts. This process may include clustering the queries and their corresponding URLs, as described additionally below, to determine states. The states may be integrated with contexts learned from examination of a large number of individual search sessions for use in generating the learned model 106.

In the example illustrated in FIG. 1, once the learned model 106 has been created, the model 106 may then be used during the online portion 104 for assisting users as they conduct searches. During the online portion 104, user inputs 108, such as search queries and/or selected URLs are received from a user during a search session. Based upon the user inputs 108, the learned model 106 is able to predict and provide to the user re-ranked search results 110, query suggestions 112, and/or URL recommendations 114. For example, based upon the inputs from the user, the learned model 106 is able to predict the context of the user's search and re-rank search results or determine what a most-likely subsequent query would be. This most likely subsequent query may be provided to the user as a suggested query, and in addition, or alternatively, the suggested query may be used to automatically determine recommended URLs.

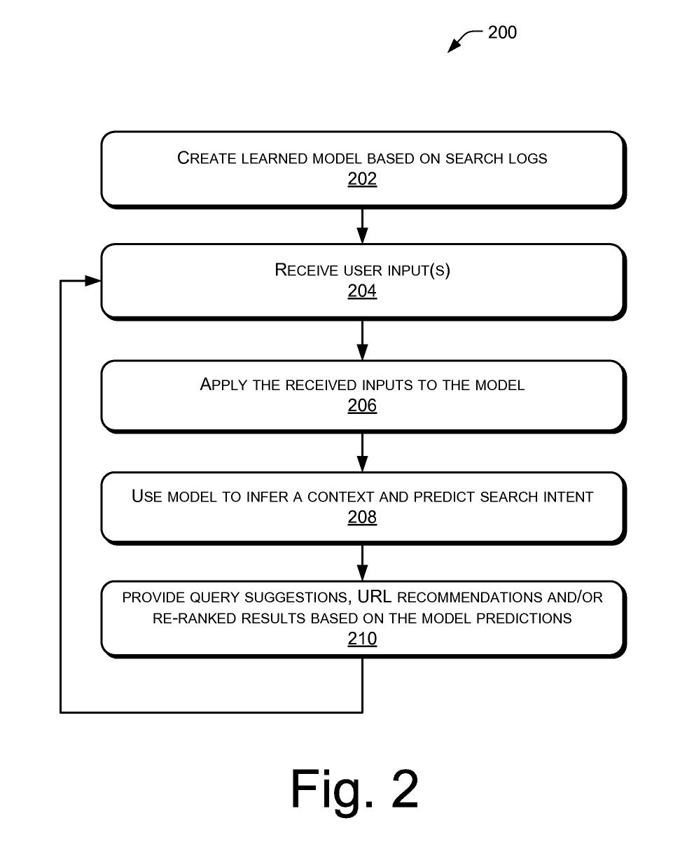

FIG. 2 illustrates a flowchart of an exemplary process 200 corresponding to the implementation of FIG. 1. As will be described below, the process 200 may be carried out by processors of one or more computing devices executing computer program code stored as computer-readable instructions on computer-readable storage media or the like.

At block 202, a learned model is created based on prior search logs. For example, during the offline stage, a large number of search logs can be processed for extracting queries and corresponding URLs that were clicked on following the queries. Correlations can be drawn between the extracted queries and URLs in conjunction with the examination of entire individual search sessions used to determine a context for creating the learned model.

At block 204, following creation of the learned model, during the online portion, one or more user inputs are received during a search session.

At block 206, the inputs received from the user are applied to the learned model to obtain output for assisting the user and improving the user's search experience. For example, the user inputs applied to the model may be one or more queries submitted by the user and/or one or more URLs clicked on by the user during the same search session.

At block 208, the model is used to infer a context of the user's search session for predicting the user's search intent, such as for predicting what the user's next query might be based upon a current query and any other inputs received from the user. For example, according to some implementations, the process may receive a short sequence of queries and clicked-on URLs from a user during the same search session and apply those to the learned model. The learned model may then operate to determine user's current search intent or a future search intent, and can use these predictions for re-ranking current search results, predicting a next likely query or recommending a URL.

At block 210, based on the one or more predictions determined by the model in response to receiving the inputs from the user, the process provides one or more of query suggestions, URL recommendations and/or re-ranked search results to the user to assist the user during the search session. Furthermore, the process may then return to block 204 to receive any additional user inputs received from the user as the search session continues, with each additional input received providing additional information to the model for more closely determining the context of the user's search session. Thus, from the foregoing, and as will be described additionally below, implementations herein are able to provide for using a learned model to determine the context of a user search session for assisting the user during the search and thereby improving the user's search experience.

Capturing the context of a user's query from the previous queries and clicks in the same search session can help determine the user's information desires. Thus, a context-aware approach to result re-ranking, query suggestion, and URL recommendation can substantially improve a user's search experience.

### Exemplary Framework

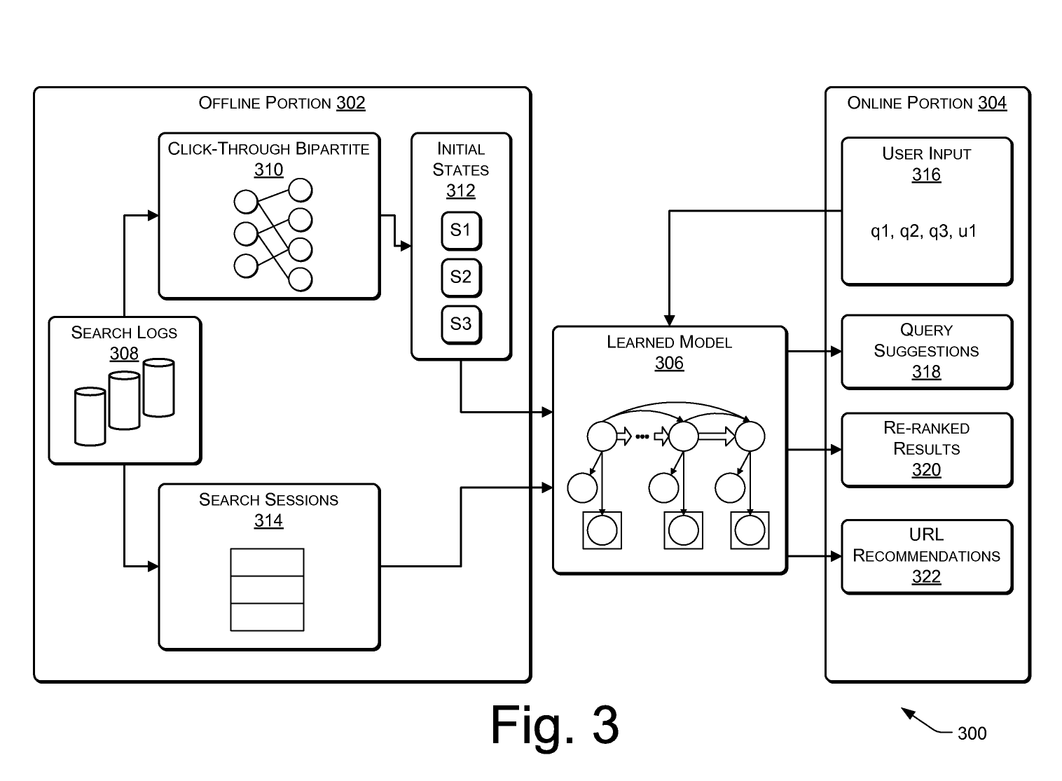

FIG. 3 illustrates a block diagram of one example of a framework 300 that may be used to provide context-aware searching according to some implementations. Framework 300 includes an offline portion 302, an online portion 304 and a learned model 306. Similar to the implementations discussed above with respect to FIG. 1, the offline portion 302 is used to generate the learned model 306, which is then used by the online portion 304 for providing context-aware search assistance to users during search sessions.

In the implementation illustrated in FIG. 3, in the offline portion 302, search logs 308 are accessed for use in generating the learned model 306. For instance, the search logs 308 may comprise a large number of stored historical searches, e.g., on the order of hundreds of millions of stored search sessions. The information contained in the search logs 308 may include information about queries and their clicked URL sets. This historical information may be gathered by recording each query presented by users to a search engine and a set of URLs that may be returned as the answer. The URLs clicked by the user, called the clicked URL set of the query, may be used to approximate the information described by or associated with the query.

The mining of the search logs 308 may operate to create a click-through bipartite 310 (e.g., a bipartite graph) that relates queries extracted from the search logs to corresponding URLs. The click-through bipartite 310 may then be used to determine one or more concepts or states 312. Additionally, the search logs may also be used to extract complete search sessions 314. Both the one or more states 312 and the query sessions 314 may be used to generate the learned model 306, as is discussed additionally below.

During the online portion 304, implementations herein may receive user input 316 (e.g., such as receiving a sequence of input queries and selected results (e.g., clicked-on URLs), as described above). The context of the user's search can then be predicted by applying the user input 316 to the learned model 306. By applying the user input to the learned model, implementations herein are able to determine one or more query suggestions 318 for the user, provide re-ranked results 320, and/or provide one or more URL recommendations 322. The one or more query suggestions 318, re-ranked results 320, and/or URL recommendations 322 may be provided to the user, such as by displaying them to the user on a display at a user's computing device through a web browser, or the like.

Additionally, while FIG. 3 illustrates an offline portion 302 and an online 304 portion, it should be understood that one or more of the elements in the offline portion 302 may be performed online, as desired. Similarly, one or more of the elements in the online portion 304 may be performed offline, as desired. Thus the elements are divided up as shown for exemplary purposes only. However, performing certain elements, or portions of elements offline, while other elements, or portions of elements are performed online, may have the advantages of speeding up any online portions of the process, e.g., by freeing up the processing for other tasks, such as performing the online elements.

### Click-Through Bipartite

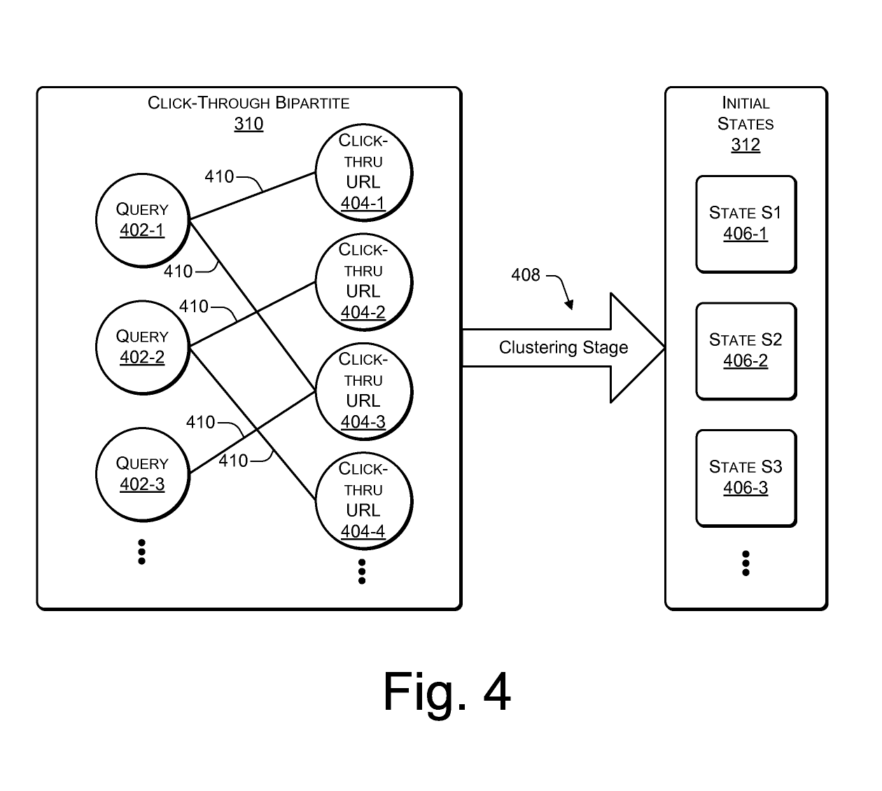

FIG. 4 illustrates an example of how states 312 may be derived from the click-through bipartite 310 of FIG. 3, according to some implementations. Thus the click-through bipartite 310 may be created by mining the search logs 308 that contain historical search data. Exemplary query nodes 402-1 through 402-3 may correspond to exemplary queries made by one or more users. Exemplary URL nodes 404-1 through 404-4 may correspond to exemplary URLs that indicate URLs that the user(s) actually clicked on or selected, as opposed to URLs that may have come up in response to a search query, but the user(s) never selected (e.g., by clicking on a link to the respective URL). Thus the URLs of URL nodes 404 may be referred to as click-through URLs.

The click-through bipartite 310 may thus correlate the queries of query nodes 402 to the click-through URLs of URL nodes 404, where each of the query nodes 402 may relate to one or more URL nodes 404. For example, the query node 402-1 is connected to two URL nodes 404-1 and 404-3, indicating that at least those corresponding two URLS were selected in response to the query of query node 402-1. One or more states 406-1 through 406-3 can be derived from the click-through bipartite 310 via a clustering stage 408 (also referred to herein as a sub-process), an example of which is described below. However, other sub-processes may be used in addition to, or instead of the exemplary clustering stage 408 described.

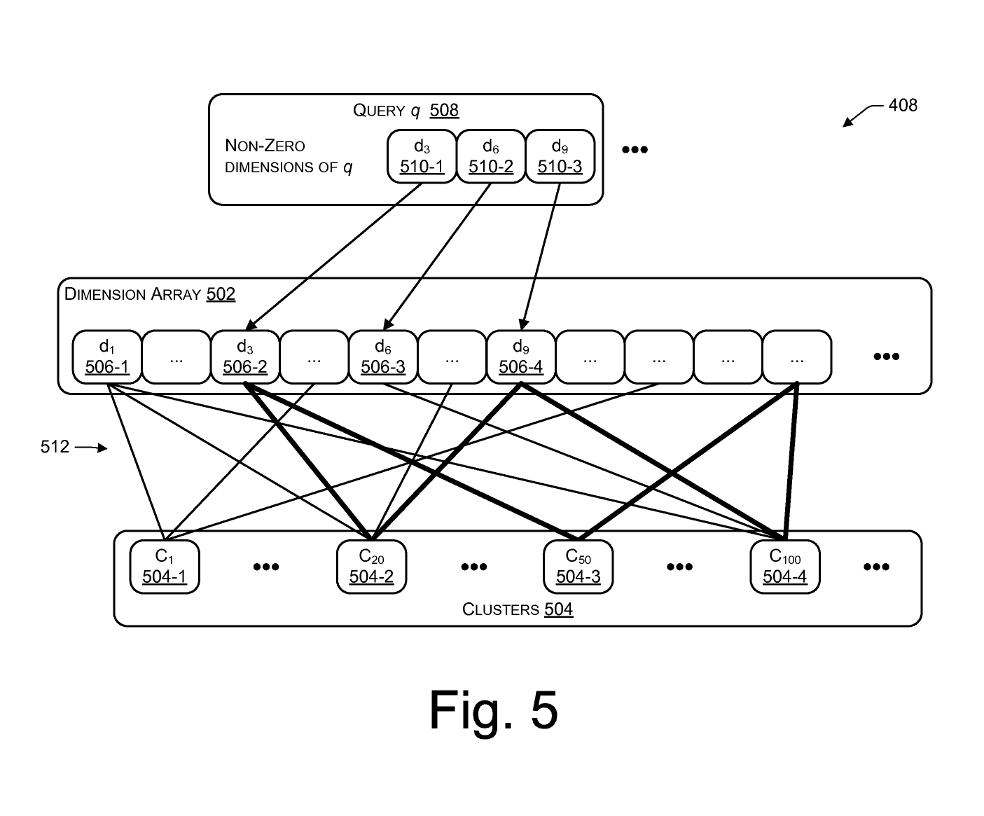

In certain implementations, the clustering stage 408 may use a data structure referred to herein as a dimension array (such as the dimension array 502 described below with reference to FIG. 5). The clustering stage 408 may address the following issues: 1) the size of the click-through bipartite 310 is very large; 2) the dimensionality of the click-through bipartite 310 is very high; 3) the number of clusters (e.g., of the resulting states 406) is unknown; and 4) the search logs 308 may evolve incrementally.

As discussed above, the search logs 308 may contain information about sequences of query and click events. From the search logs 308, implementations herein may construct the click-through bipartite 310 as follows. A query node 402 may be created for one or more of the unique queries in the search logs 308. Additionally, a URL node 404 may be created for each unique URL in the search logs 308. An edge eᵢⱼ 410 may be created between a query node qᵢ 402 and a URL node uⱼ 404 if the URL uⱼ is a clicked-on (selected) URL of the query node qᵢ. A weight wᵢⱼ (not shown) of edge eᵢⱼ 410 may represent the total number of times that a URL node uⱼ is a click of a query node qᵢ aggregated over the entirety of the search logs 308.

Furthermore, the click-through bipartite 310 may be used to locate and identify similar queries. Specifically, if two queries share many of the same clicked URLs, the queries may be found to be similar to each other. From the click-through bipartite 310, implementations herein may represent each query qᵢ as a normalized vector, where each dimension may correspond to one URL in the click-through bipartite 310. To be specific, given the click-through bipartite 310, let Q and Ube the sets of query nodes and URL nodes, respectively, in the click-through bipartite 310. The j-th element of the feature vector of a query qᵢ∉Q is: \vec{q}ᵢ[j]=i norm (wᵢⱼ) if an edge eᵢⱼ exists, or 0 otherwise, where uⱼ∉U, and

$$norm ( {w}_{ij} ) = \frac{{w}_{ij}}{\sqrt{{\sum }_{∀ {e}_{ik}} {w}_{ik}^{2}}} .$$

The distance between two queries qᵢ and qⱼ may be measured by the Euclidean distance between their normalized feature vectors, namely:

$$distance ( {q}_{i} , {q}_{j} ) = \sqrt{{\sum }_{{u}_{k} ∈ U} {( \vec{{q}_{i}} [ k ] - \vec{{q}_{j}} [ k ] )}^{2}} .$$

### Clustering Stage

FIG. 5 illustrates how the clustering stage 408 may use a dimension array 502 to generate one or more clusters C 504 (also referred to as concepts or states), according to certain implementations. The dimension array 502 having dimensions d 506 may be used for clustering queries 508, where each of the clusters C 504-1 through 504-4, in the illustrated example, may correspond to one or more states 312 of FIGS. 3-4. The clustering stage 408 may scan the data set (e.g., the query nodes 402 and URL nodes 404 contained in the click-through bipartite 310). For each query q 508 (e.g., each of the query nodes 402), the clustering stage 408 may find any non-zero dimensions d 510 (e.g., dimensions d₃ 510-1, d₆ 510-2, d₉ 510-3 in the illustrated example), and then may follow any corresponding links 512 in the dimension array 502 to insert the query q 508 into an existing cluster 504 or initiate a new cluster 504 with the query q 508.

For example, the clustering stage may summarize individual queries into clusters or concepts, where each cluster may represent a small set of queries that are similar to each other. By using clusters to describe contexts, the method may address the sparseness of queries and interpret the search intents of users. As described above, to find clusters or concepts in the queries, the clustering stage may use the connected clicked-through URLs as answers to queries. Thus, the implementations herein are able to determine concepts by clustering the queries contained in the click-through bipartite 310 that are determined to be similar.

An example of an algorithm that may be used for executing a portion of the clustering stage 408 in some implementations is set forth below:

Example Clustering Algorithm for Clustering queries.

| Input: the set of queries Q and the diameter | |
|---|---|
| threshold Dmax; | |
| Output: the set of clusters Θ; | |
| Initialization: dim_array[d] = φ for each | |
| dimension d; | |
| 1: | for each query qᵢ ∈ Q do |

| | |
|---|---|
| 2: | C-Set = φ; |
| 3: | for each non-zero dimension d of vector |

| (qi) do | |
|---|---|
| 4: | C-Set ∪ = dim array[d]; |

| | |
|---|---|
| 5: | C = arg min_{C}, ∈ _{C-set} distance(qi;C′); |
| 6: | if diameter(C ∪ {qi}) ≦ Dmax then |

| 7: | C ∪ = {Qi}; update the centroid and |
|---|---|
| diameter of C; | |
| 8: | else C = new cluster ({qi}); Θ ∪= C; |
| 9: | for each non-zero dimension d of vector |

| (qi) do | |
|---|---|
| 10: | if C ∉ dim_array[d] then link C to |

| dim_array[d]; | |
|---|---|
| 11: | return Θ |

In certain implementations, a cluster C 504 may correspond to a set of queries 508. The normalized centroid of each cluster may be determined by:

$$\vec{c} = norm ( \frac{{\sum }_{{q}_{i} ∈ C} \vec{{q}_{i}}}{\vert C \vert} ) ,$$

where |C| is the number of queries in C.

Furthermore, the distance between a query q and a cluster C may be given by

$$distance ( q , C ) = \sqrt{{\sum }_{{u}_{k} ∈ U} {( \vec{q} [ k ] - \vec{c} [ k ] )}^{2}} .$$

The method may adopt the diameter measure to evaluate the compactness of a cluster, i.e.,

$$D = \sqrt{\frac{{\sum }_{i = 1}^{\vert C \vert} {\sum }_{j = 1}^{\vert C \vert} {( \vec{{q}_{i}} - \vec{{q}_{j}} )}^{2}}{\vert C \vert ( \vert C \vert - 1 )}} .$$

The method may use a diameter parameter Dₘₐₓ to control the granularity of clusters: every cluster has a diameter at most Dₘₐₓ.

In certain implementations, the clustering stage may use one scan of the queries 508 of query nodes 402, although in other implementations, the clustering stage may use more than one scan/set of queries. The clustering stage may create a set of clusters 504 as the queries in the bipartite 310 are scanned. For each query q 508, the method may find the closest cluster C 504 to query q 508 among the clusters C 504 obtained so far, and then test the diameter of C∪{q}. If the diameter is not larger than Dₘₐₓ, then the query q may be assigned to the cluster C 504, and the cluster C 504 may be updated to C∪{q}. Otherwise, a new cluster C 504 containing only the query q currently being processed may be created.

In certain implementations, where the queries in the click-through bipartite 310 may be sparse, to find out the closest cluster to a query q, the clustering stage 408 may check the clusters 504 which contain at least one query in Q_{q}. In certain implementations, since each query may only belong to one cluster, the average number of clusters to be checked may be relatively small.

Thus, based on the above idea, the clustering stage 408 may use a data structure, such as dimension array 502, as illustrated in FIG. 5, to facilitate the clustering procedure. Each entry of the dimension array 502 may correspond to one dimension dᵢ in the bipartite 310, and may link to a set of clusters Θᵢ, where each cluster C∉Θᵢ, and which contains at least one member query qⱼ such that (vector qⱼ)≠0. As an example, for the query q 508 of FIG. 5, if the non-zero dimensions of (vector q) are d₃ 510-1, d₆ 510-2, and d₉ 510-3, then, to find the closest cluster to query q 508, the method can union the clusters C₂₀ 504-2, C₅₀ 504-3, C₁₀₀ 504-4, which are linked by the third, the sixth, and the ninth entries of the dimension array 502, respectively, namely d₃ 506-2, d₆ 506-3, d₉ 506-4. In certain implementations, the closest cluster to query q 508 may be a member of the union, i.e., Θᵢ.

In certain implementations, where the click-through bipartite 310 may be sparse, the clusters 504 may be derived by finding the connected components from the bipartite 310. To be specific, two queries qₛ and qₜ may be connected if there exists a query-URL path qₛ=>u₁=>q₁=>u₂, . . . , qₜ where a pair of adjacent query and URL in the path may be connected by an edge. A cluster of queries may be defined as a maximal set of connected queries. In certain implementations, this variation of the clustering method may not use a specified maximum diameter parameter Dₘₐₓ. However, in certain implementations, where the bipartite 310 may be both well connected and sparse (e.g., where almost all queries, no matter similar or not, may be included in a single connected component), a different approach may be used. Specifically, implementations herein may operate to prune the queries and URLs without degrading the quality of clusters. For instance, edges with low weights may be formed due to users' random clicks, and thus may be removed to reduce noise. For example, let eᵢⱼ be the edge connecting query qᵢ and uⱼ, and wᵢⱼ be the weight of eᵢⱼ. Moreover, let wᵢ be the sum of the weights of all the edges where qᵢ is one endpoint, i.e., wᵢ=Σⱼwᵢⱼ. The method may prune an edge eᵢⱼ if the absolute weight wᵢⱼ≦τ_{abs} or the relative weight wᵢⱼ/wᵢ≦τᵣₑₗ, where τ_{abs} and τᵣₑₗ may be user specified thresholds. Exemplary values of τ_{abs} and τᵣₑₗ that have produced satisfactory results during testing are τ_{abs}=5 and τᵣₑₗ=0.1. After pruning low-weight edges, some implementations may further remove any queries and the URL nodes whose degrees become zero.

### Session Sequence Extraction

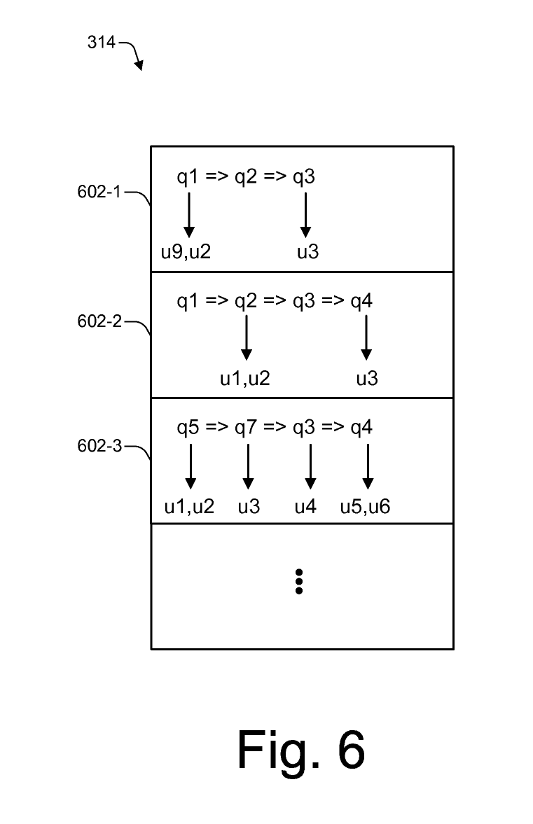

FIG. 6 illustrates how the search sessions 314 may be extracted from the search logs 308 of FIG. 3, according to some implementations. As discussed above, to learn a context-aware model, query contexts can be determined from historical user search sessions. The session data can be constructed by extracting anonymous individual user behavior data from an anonymous search log as a separate stream of query/click events, and then segmenting each individual search stream into one or more search session sequences 602-1, 602-2, 602-3, and so forth. For example, a search session sequence 602-1 extracted from the search logs includes a first query q1 submitted by a user that resulted in the user clicking on URLs u9 and u2. This user then submitted a second query q2 that resulted in no clicks, then submitted a query q3 that resulted in a click on URL u3, and the session then ended. In a separate search sequence 602-2, a user submitted query q1, which resulted in no clicks, and then the user submitted query q2, which resulted in clicks on URLs u1, u2. The user next submitted query q3, resulting in no clicks, submitted query q4, which resulted in a click on URL u3, and the session ended. Accordingly, it may be seen that the sequences 602 of queries and URLs of a huge number of search sessions can be extracted for providing additional associations between queries (and URLs) based on the sequences of queries extracted to enable prediction of user intent and context. This information can reduce the computation complexity from an exponential magnitude (such as is present in many sequential pattern mining algorithms) to quadratic magnitude. In certain implementations, other mining methods may be used in addition to, or instead of, the one described, such as sequential pattern mining algorithms that enumerate most or all of the combinations of concepts, among others.

As pointed out above, the context of a user query may include the immediately preceding queries issued by the same anonymous user. To learn a context-aware query suggestion model, the method may collect query contexts from the user search sessions 314 by extract query/URL sequences, as discussed above. For instance, queries in the same search sessions are often related. Further, since users may formulate different queries to describe the same search intent, just mining patterns of individual queries may miss relevant patterns for determining context. Accordingly, these patterns can be captured from the sequences.

In certain implementations, the session data can be constructed in three steps, although other ways to construct session data are contemplated that use more or less steps, as desired. First, each anonymous user's behavior data is extracted from the search log 308 as an individual separate stream of query/click events. Second, each anonymous user's stream is segmented into sessions based on the following rule: two consecutive events (either query or click) are segmented into two different sessions if the time interval between them exceeds a predetermined period of time (for example, in some implementations, the predetermined period of time may be 30 minutes, however, the time interval is exemplary only and other values may be used instead). The search sessions 314 can then be used as training data for building the model. For example, a user will typically refine the queries and/or explore related information about his or her search intent during a session. Each of these sequences of behaviors by users can be used for forming the model. For example, as discussed above, a user will often start with a first query, and then further refine the query with subsequent queries to focus more directly on the search intent. Thus, a sequence of queries is a search session (and any URLs clicked on) can be used for inferring a search intent for the session. Further, because the number of search logs used for training the model is very large, random actions by a particular user, such as the user getting distracted by a different subject, clicking on an unrelated link, or the like, tend to be averaged out from influencing the model.

### Exemplary Model

One example of a suitable model that may be used according to implementations herein is a variable length Hidden Markov Model (vlHMM) configured to model query contexts. Because search intents are not observable, the vlHMM can be configured so that search intent is a hidden variable. For example, different users may submit different queries to describe the same search intent. For instance, to search for information on “Microsoft Research Asia”, queries such as “Microsoft Research Asia”, “MSRA” or “MS Research Beijing” may be formulated. Moreover, even when two users raise exactly the same query, they may choose different URLs to browse.

Accordingly, if only individual queries and URLs are modeled as states, then this not only increases the number of states (and thus the complexity of the model), but also loses the semantic relationships among the queries and the URLs clicked on under the same search intent. Consequently, implementations herein assume that queries and clicks are generated by some hidden states where each hidden state corresponds to one search intent.

For context-aware searching, some implementations herein apply a higher order HMM. This is because, typically, the probability distribution of the current state Sₜ is not independent of the previous states S₁, . . . , Sₜ₋₂, given the immediately previous state Sₜ₋₁. For example, given that a user searched for “Ford cars” at a point in time t₁, the probability that the user searches for “GMC cars” at the current point in time t can depend on the states s₁, . . . , sₜ₋₂. As an intuitive instance, that probability will be smaller if the user searched for “GMC cars” at any point in time before t−1. Therefore, some implementations herein consider higher order HMMs rather than merely using a first order HMM. In particular, some implementations herein consider the vlHMM instead of a fixed-length HMM because the vlHMM is more flexible to adapt to variable lengths of user interactions in different search sessions.

Given a set of hidden states {S₁, . . . , S_{Ns}}, a set of queries {q₁, . . . ; q_{Nq}}, a set of URLs {U₁, . . . , u_{Nu}}, and the maximal length Tₘₐₓ of state sequences, a vlHMM is a probability model that can be defined as follows.

The transition probability distribution Δ={P(sᵢ|Sⱼ)}, where Sⱼ is a state sequence of length Tⱼ<Tₘₐₓ, P(sᵢ|Sⱼ) is the probability that a user transits to state sᵢ given the previous states s_{j,1}, s_{j,2}, . . . , s_{j,Tj}, and s_{j,t} (1≦t≦Tⱼ) is the t-th state in sequence Sⱼ.

The initial state distribution Ψ={P(sᵢ)}, where P(Sᵢ) is the probability that state Sᵢ occurs as the first element of a state sequence.

The emission probability distribution for each state sequence Λ={P(q,U|Sⱼ)}, where q is a query, U is a set of URLs, Sⱼ is a state sequence of length Tⱼ≦Tₘₐₓ, and P(q,U|Sⱼ) is the joint probability that a user raises the query q and clicks the set of URLs U from state s_{j,Tj} after the user's (Tⱼ−1) steps of transitions from state s_{j,1} to s_{j,Tj}.

To keep the model simple, given a user is currently at state S_{j,Tj}, implementations herein may assume the emission probability is independent of the user's previous search states s_{j,1}, . . . , S_{j,Tj-1}, i.e., P(q,U|Sⱼ)≡P(q,U|S_{j,Tj}). Moreover, implementations herein may assume that query q and URLs U are conditionally independent given the state S_{j,Tj}, i.e., P(q,U|s_{j,Tj})≡P(q|s_{j,Tj}). Under the above two assumptions, the emission probability distribution Λ becomes (Λ_{q}, Λᵤ)≡({P(q|sᵢ)}, {P(u|sᵢ)}).

According to implementations herein, the task of training a vlHMM model is to learn the parameters Θ=(Ψ, Δ, Λ_{q}, Λᵤ) from search logs. A search log is basically a sequence of queries and click events. The implementations can extract and sort each anonymous user's events and then derive sessions based on a method wherein two consecutive events (either queries or clicks) are segmented into two separate sessions if the time interval between the two consecutive events exceeds a predetermined time threshold (e.g., 30 minutes). The sessions formed as such are then used as training examples. For example, let X={O₁, . . . , O_{N}} be the set of training sessions, where a session Oₙ (1≦n≦N) of length Tₙ is a sequence of pairs [(q_{n,1},U_{n,1}) . . . (q_{nTn},U_{nTn})], where q_{n,t} and U_{n,j t} (1≦t≦Tₙ) are the t-th query and the set of clicked URLs among the query results, respectively. Moreover, implementations herein use U_{n,t,k} to denote the k-th URL (1≦k≦|U_{n,t}|) in U_{n,t}. The maximum likelihood method can be used to estimate parameters for Θ in order to find Θ* such that

$${Θ}^{*} = arg {max}_{Θ} ln P ( X \vert Θ ) = arg {max}_{Θ} {\sum }_{n} ln P ( {O}_{n} \vert Θ ) \qquad ( 1 )$$

For example, if Y={S₁, . . . , S_{M}} is the set of all possible state sequences, s_{m,t} is the t-th state in Sₘ∉Y (1≦m≦M), and Sₘ^{t-1} is the subsequence s_{m,1}, . . . , s_{m,t-1} of Sₘ. Then, the likelihood can be written as ln P(Oₙ|Θ)=ln ΣₘP(Oₙ, Sₘ|Θ), and the joint distribution can be written as

$$\begin{matrix}P ( {O}_{n} , {S}_{m} \vert Θ ) = P ( {O}_{n} \vert {S}_{m} , Θ ) P ( {S}_{m} \vert Θ ) \\ = ( {\prod }_{t = 1}^{{T}_{n}} P ( {q}_{n , t} \vert {s}_{m , t} ) {\prod }_{k} P ( {u}_{n , t , k} \vert {s}_{m , t} ) ) \times \\ ( P ( {s}_{m , 1} {\prod }_{t = 2}^{{T}_{n}} P ( {s}_{m , t} \vert {s}_{m}^{t - 1} ) ) )\end{matrix} \qquad ( 2 )$$

Since optimizing the likelihood function in an analytic way may not be possible, implementations herein employ an iterative approach and apply the Expectation Maximization algorithm (EM algorithm for short—see, e.g., Dempster, A. P., et al., “Maximal Likelihood from Incomplete Data Via the EM Algorithm”, Journal of the Royal Statistical Society, Ser B(39):1-38, 1977).

Applying this algorithm, at the E-Step, produces:

$$\begin{matrix}Q ( Θ , {Θ}^{( i - 1 )} ) = E [ ln P ( X , Y \vert Θ ) \vert X , {Θ}^{( i - 1 )} ] \\ = {\sum }_{n , m} P ( {S}_{m} \vert {O}_{n} , {Θ}^{( i - 1 )} ) ln P ( {O}_{n} , {S}_{m} \vert Θ ) ] ,\end{matrix} \qquad ( 3 )$$

where Θ⁽ⁱ⁻¹⁾ is the set of parameter values estimated in the last round of iteration. P(Sₘ|Oₙ,Θ⁽ⁱ⁻¹⁾) can be written as

$$P ( {S}_{m} \vert {O}_{n} , {Θ}^{( i - 1 )} ) = \frac{P ( {O}_{n} , {S}_{m} \vert {Θ}^{( i - 1 )} )}{P ( {O}_{n} \vert {Θ}^{( i - 1 )} )} \qquad ( 4 )$$

Substituting Equation 2 into Equation 4, and then substituting Equations 2 and 4 into Equation 3, produces the following:

$$Q ( Θ , {Θ}^{( i - 1 )} ) ∝ {\sum }_{n , m} ( {\prod }_{t = 1}^{{T}_{n}} {P}^{( i - 1 )} ( {q}_{n , t} \vert {s}_{m , t} ) {\prod }_{k} {P}^{( i - 1 )} ( {u}_{n , t , k} \vert {s}_{m , t} ) ) \times ( {P}^{( i - 1 )} ( {s}_{m , 1} ) {\prod }_{t = 2}^{{T}_{n}} {P}^{( i - 1 )} ( {s}_{m , t} \vert {s}_{m}^{t - 1} ) ) + ( {\sum }_{t = 1}^{{T}_{n}} ln P ( {q}_{n , t} \vert {s}_{m , t} ) + {\sum }_{t = 1}^{{T}_{n}} {\sum }_{k} ln P ( {u}_{n , t , k} \vert {s}_{m , t} ) + ln P ( {s}_{m , 1} ) + {\sum }_{t = 2}^{{T}_{n}} ln P ( {s}_{m , t} \vert {S}_{m}^{t - 1} ) ) .$$

At the M-Step, Q(Θ, Θ⁽ⁱ⁻⁻⁾) is maximized iteratively using the following formulas until the iteration converges.

$$\begin{matrix}P ( {s}_{i} ) = \frac{{\sum }_{n , m} P ( {S}_{m} \vert {O}_{n} , {Θ}^{( i - 1 )} ) δ ( {s}_{m , 1} = {s}_{i} )}{{\sum }_{n , m} P ( {S}_{m} \vert {O}_{n} , {Θ}^{( i - 1 )} )} & ( 5 ) \\ P ( q \vert {s}_{i} ) = \frac{{\sum }_{n , m} P ( {S}_{m} \vert {O}_{n} , {Θ}^{( i - 1 )} ) {\sum }_{t} δ ( {s}_{m , t} = {s}_{i} Λ q = {q}_{n , t} )}{{\sum }_{n , m} P ( {S}_{m} \vert {O}_{n} , {Θ}^{( i - 1 )} ) {\sum }_{t} δ ( {s}_{m , t} = {s}_{i} )} & ( 6 ) \\ P ( u \vert {s}_{i} ) = \frac{{\sum }_{n , m} P ( {S}_{m} \vert {O}_{n} , {Θ}^{( i - 1 )} ) {\sum }_{t} δ ( {s}_{m , t} = {s}_{i} Λ q ∈ {U}_{n , t} )}{{\sum }_{n , m} P ( {S}_{m} \vert {O}_{n} , {Θ}^{( i - 1 )} ) {\sum }_{t} δ ( {s}_{m , t} = {s}_{i} )} & ( 7 ) \\ P ( {s}_{i} \vert {S}_{j} ) = \frac{{\sum }_{n , m} P ( {S}_{m} \vert {O}_{n} , {Θ}^{( i - 1 )} ) δ ( ∃ t {S}_{m}^{t - 1} = {S}_{j} Λ {s}_{m , t} = {s}_{i} )}{{\sum }_{n , m} P ( {S}_{m} \vert {O}_{n} , {Θ}^{( i - 1 )} ) δ ( ∃ {tS}_{m}^{t - 1} = {S}_{j} )} & ( 8 )\end{matrix}$$

In the above equations, δ(p) is a Boolean function indicating whether predicate p is true (=1) or false (=0).

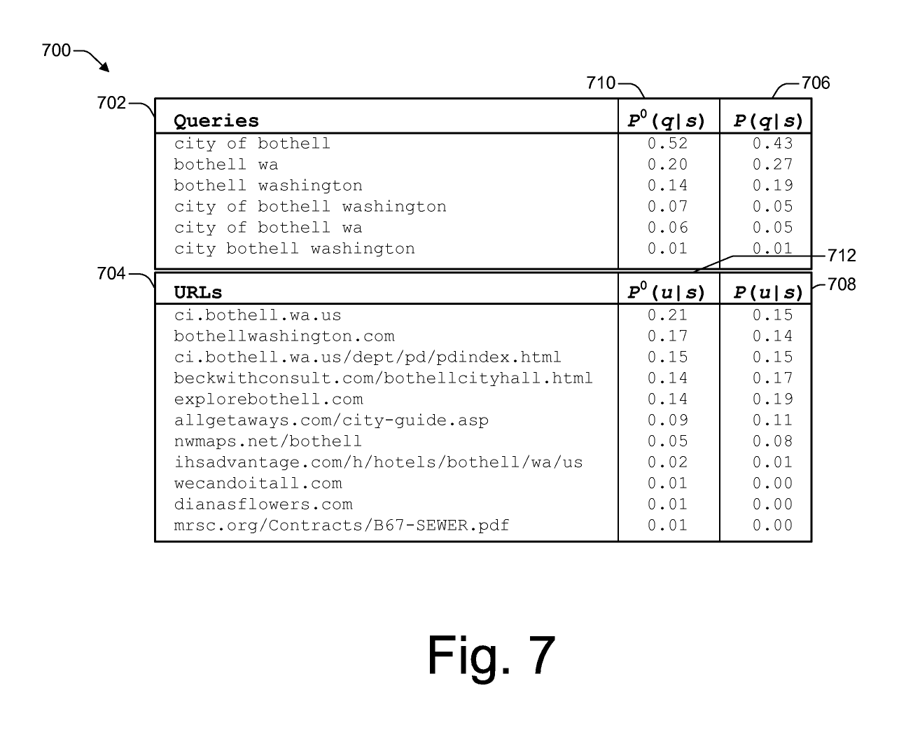

As an example, FIG. 7 illustrates a state which is a cluster C 700 mined from a real data set. The cluster C 700 includes a query cluster Q 702 of queries, which is a set of queries q that are similar to each other that have been added to the query cluster Q 702. Cluster C 700 further includes a URL cluster U 704 of URLs u associated with the query cluster Q 702. Thus, the cluster C 700 can be represented by a duple (Q,U) of query cluster Q 702 and URL cluster U 704, which corresponds to a hidden state s. The total number of hidden states is determined by the total number of clusters C. FIG. 7 further illustrates the probability distribution P(q|s) 706 for the queries and the probability distribution P(u|s) 708 for the corresponding URLs. FIG. 7 further illustrates the initial emission probability distribution P⁰ (q|s) 710 for the queries and the initial emission probability distribution P⁰ (u|s) 712 for the corresponding URLs.

Training a Very Large vlHMM

In order to apply the EM algorithm on a huge amount of search log data, implementations herein adopt innovative techniques. For instance, the EM algorithm typically requires a user-specified number of hidden states. However, according to the model herein, the hidden states correspond to users' search intents, the number of which is unknown. To address this challenge, implementations herein apply the search log mining techniques discussed above with reference to FIGS. 3-6 as a prior process to the parameter learning process. Thus, implementations construct the click-through bipartite 310 and derive a collection of clusters C 504, as described above. For each query cluster Q of queries (wherein a query cluster Q is a set of one or more queries q determined to be similar), implementations herein find a set or URL cluster of URLs U such that each URL u∉U is connected to at least one query q∉Q in the click-through bipartite. A duple of a query cluster and a URL cluster (Q, U) is considered to correspond to a hidden state. The total number of hidden states is determined by the total number of clusters C.

Additionally, search logs may contain hundreds of millions of training sessions. It may be impractical to learn a vlHMM from such a huge training data set using a single computing device because it is not possible to maintain such a large data set in memory. To address this challenge, implementations herein may deploy the learning task on a distributed computing system and may adopt a map-reduce programming paradigm, or other distributed computing strategy.

Furthermore, although the distributed computing implementations partition the training data into multiple computing devices, each computing device still may hold the values of all parameters to enable local estimation. Since the log data usually contains millions of unique queries and URLs, the space of parameters is extremely large. As an example, a real experimental data set produced more than 1030 parameters. Conventionally, the EM algorithm in its original form would not be able to finish in practical time even one round of iterations. To address this challenge, implementations herein utilize an initialization strategy based on the clusters mined from the click-through bipartite. This initialization strategy can reduce the number of parameters to be re-estimated in each round of iteration to a much smaller number. Moreover, theoretically, the number of parameters has an upper bound.

### Distributed Learning of Parameters

Map-Reduce is an example of a suitable programming model or strategy according to some implementations for distributed processing of a large data set (see, e.g., Dean, J., et al. “MapReduce: simplified data processing on large clusters”, OSDI'04, pages 137-150, 2004). In the map stage, each computing device (called a process node) receives a subset of data as input and produces a set of intermediate key/value pairs. In the reduce stage, each process node merges all intermediate values associated with the same intermediate key and outputs the final computation results.

In the learning process for learning the model, implementations herein first partition the training data into subsets and distribute each subset to a process node, such as one of a plurality of computing devices that are configured to carry out the learning process. In the map stage, each process node scans the assigned subset of training data once. For each training session Oₙ, the process node infers the posterior probability p_{n,m}=P(Sₘ|Oₙ,Θ⁽ⁱ⁻¹⁾) by Equation 4 set forth above for each possible state sequence Sₘ and emits the key/value pairs as shown in the table below.

| Key | Value |
|---|---|
| sᵢ | Value_{n, 1} = Σₘp_{n, m}δ(s_{m, 1} = sᵢ) |
| | Value_{n, 2} = Σₘp_{n, m} |
| (sᵢ\|qⱼ) | Value_{n, 1} = Σₘp_{n, m}Σₜδ(s_{m, t} = sᵢΛqⱼ = q_{n, t}) |
| | Value_{n, 2} = Σₘp_{n, m}Σₜδ(s_{m, t} = sᵢ) |
| (sᵢ\|uⱼ) | Value_{n, 1} = Σₘp_{n, m}Σₜδ(s_{m, 1} = sᵢΛuⱼ ε U_{n, t}) |
| | Value_{n, 2} = Σₘp_{n, m}Σₜδ(s_{m, t} = sᵢ) |
| (sᵢ\|Sⱼ) | Value_{n, 1} = Σₘp_{n, m}δ(∃t Sₘ^{t-1} = SⱼΛs_{m, t} = sᵢ) |
| | Value_{n, 2} = Σₘp_{n, m}δ(∃t Sₘ^{t-1} = Sⱼ) |

In the reduce stage, each process node collects all values for an intermediate key. For example, suppose the intermediate key Sᵢ is assigned to process node nₖ. Then nₖ receives a list of values {(Value_{i,1}, Value_{i,2})} (1≦i≦N) and derives P(sᵢ) by Σᵢ Value_{i,1}/Σᵢ Value_{i,2}. The other parameters, P(q|sᵢ), P(u|s₁), and P(sᵢ|Sⱼ) are computed in a similar way.

### Assigning Initial Values

In the example of the vlHMM model set forth herein, implementations have four sets of parameters, the initial state probabilities {P(sᵢ)}, the query emission probabilities {P(q|sᵢ)}, the URL emission probabilities {P(u|sᵢ)}, and the transition probabilities {P(sᵢ|Sⱼ)}. Suppose the number of states is Nₛ, the number of unique queries is N_{q}, the number of unique URLs is Nᵤ, and the maximal length of a training session is Tₘₐₓ. Then, |{P(sᵢ)}|=Nₛ, |{P(q|sᵢ)}|=NₛN_{q}, |{P(u|sᵢ)}|=Nₛ Nᵤ, |{P(sᵢ|Sⱼ)}|=Σₜ₌₂^{Tmax}Ns^{t-1}, and the total number of parameters is N=Nₛ(1+N_{q}+Nᵤ+Σₜ₌₂^{Tmax}Ns^{t-1}). Since a search log may contain millions of unique queries and URLs, and there may be millions of states derived from the click-through bipartite, it is impractical to estimate all parameters straightforwardly. Consequently, implementations herein reduce the number of parameters that need to be re-estimated in each round of iteration. Some implementations herein, take advantage of the semantic correlation among queries, URLs, and search intents. For example, a user is unlikely to raise the query “Harry Potter” to search for the official web site of Beijing Olympic 2008. Similarly, a user who raises query “Beijing Olympic 2008” is unlikely to click on a URL for Harry Potter. This observation suggests that, although there is a huge space of possible parameters, the optimal solution is sparse, i.e., the values of most emission and transition probabilities are zero.

To reflect the inherent relationship among queries, URLs, and search intents, implementations herein assign the initial parameter values based on the correspondence between a cluster Cᵢ=(Qᵢ, Uᵢ) and a state sᵢ. As illustrated in FIG. 7, the queries Qᵢ and the URLs Uᵢ of a cluster Cᵢ are semantically correlated and jointly reflect the search intent represented by state sᵢ. According to some implementations, a nonzero probability can be assigned to P(q|sᵢ) and P(u|sᵢ), respectively if q∉Cᵢ and u∉Cᵢ. However, such assignments can make the model deterministic since each query can belong to only one cluster.

Alternatively, some implementations herein can conduct random walks on the click-through bipartite 310. According to these implementations, P(q|sᵢ) and P(u|sᵢ) can be initialized as the average probability of the random walks that start from q (or u) and stop at the queries (or URLs) belonging to cluster Cᵢ. However, as indicated above, the click-through bipartite is highly connected, i.e., there may exist paths between two completely unrelated queries or URLs. Consequently, random walks may assign undesirably large emission probabilities to queries and URLs generated by an irrelevant search intent.

According to some implementations, an initialization strategy may balance the above two approaches. These implementations apply random walks up to a restricted number of steps. Such an initialization allows a query (as well as a URL) to represent multiple search intents, and at the same time avoids the problem of assigning undesirably large emission probabilities.

For example, these implementations may limit random walks within two steps. In the first step of random walk, each cluster Cᵢ=(Qᵢ, Uᵢ) is expanded into Cᵢ′=(Qᵢ′, Uᵢ) where Qᵢ′ is a set of queries such that each query q′∉Qᵢ′ is connected to at least one URL u∉Uᵢ in the click-through bipartite. In the second step of random walk, Cᵢ′ is further expanded to Cᵢ″=(Qᵢ′, Uᵢ′), where Uᵢ′ is a set of URLs such that each URL u′∉Uᵢ′ is connected to at least one query q′∉Qᵢ′. Then the following formulas can be used:

$${P}^{0} ( q \vert {s}_{i} ) = \frac{{\sum }_{ω ∈ {U}_{i}^{′}} Count ( q , {u}^{′} )}{{\sum }_{{q}^{′} ∈ {Q}_{i`}^{′}} {\sum }_{{u}^{′} ∈ {U}_{i}^{′}} Count ( q , {u}^{′} )}$$

$${P}^{0} ( u \vert {s}_{i} ) = \frac{{\sum }_{{q}^{′} ∈ {Q}_{i}^{′}} Count ( {q}^{′} , u )}{{\sum }_{{q}^{′} ∈ {Q}_{i`}^{′}} {\sum }_{{u}^{′} ∈ {U}_{i}^{′}} Count ( {q}^{′} , {u}^{′} )}$$

where Count(q,u) is the number of times that a URL is clicked as an answer to a query in the search log.

Lemma 1. The initial emission probabilities have the following properties: the query emission probability at the i-th round of iteration P^{i(q|s}ᵢ)=0 if the initial value P⁰(q|sᵢ)=0.

For instance, because the denominator in Equation 6 is a constant, it is possible to only consider the numerator. Thus, for any pair of Oₙ and Sₘ, if Oₙ does not contain query q, the enumerator is zero since Σₜδ(s_{m,t}=sᵢ [symbol] q_{n,t}=q)=0.

Furthermore, suppose Oₙ contains query q. Without loss of generality, suppose q appears in Oₙ only at step t₁, i.e., q_{n,t1}=q. Then, if s_{m,t1}≠sᵢ, the enumerator is zero since Σₜδ(s_{m,t}=sᵢ [symbol] q_{n,t}=q)=δ(s_{m,t1}=sᵢ [symbol] q_{n,t1}=q)=0.

Last, if s_{m,t1}=sᵢ and q_{n,t1}=q, then P(Oₙ|Sₘ,Θⁱ⁻¹⁾)=P⁽ⁱ⁻¹⁾(q|sᵢ)(Πₜ≠ₜ₁P⁽ⁱ⁻¹⁾(q_{n,t}|s_{m,t}))(ΠₜP⁽ⁱ⁻¹⁾(U_{n,t}|s_{m,t})). Therefore, if P⁽ⁱ⁻¹⁾(q|sᵢ)=0, P(Oₙ|Sₘ, Θ⁽ⁱ⁻¹⁾)=0, then P(Sₘ|Oₙ, Θ⁽ⁱ⁻¹⁾)=0 (Equation 4).

In summary, for any Oₙ and Sₘ, if P⁽ⁱ⁻¹⁾(q|sᵢ)=0, P(Sₘ|Oₙ, Θ⁽ⁱ⁻¹⁾)Σₜδ(s_{m,t}=sᵢ [symbol] q_{n,t}=q)=0 and Pⁱ(q|sᵢ)=0. By induction, this yields Pⁱ(q|sᵢ)=0 if the initial value P⁰(q|sᵢ)=0 (i.e., Lemma 1).

Lemma 2. Similarly, it can also be shown that the URL emission probability at the i-th round of iteration Pⁱ(u|sᵢ)=0 if the initial value P⁰(u|sᵢ)=0.

Based on the foregoing, for each training session Oₙ, implementations herein can construct a set of candidate state sequences Γₙ which are likely to generate Oₙ. For example, let q_{n,t} and {u_{n,t,k}} be the t-th query and the t-th set of clicked URLs in Oₙ, respectively, and Cand_{n,t} be the set of states s such that (P⁰(q_{n,t}|s)≠0) [symbol] (∀P⁰(u_{n,t,k}|s)≠0). Then, since P(Oₙ|Sₘ, Θ⁽ⁱ⁻¹⁾)=0 for any Sₘ if s_{m,t}∈Cand_{n,t}. Therefore, the set of candidate state sequences Γₙ for Oₙ can be constructed by joining Cand_{n,1}, . . . , Cand_{n,Tn}. It is easy to see that for any Sₘ∈Γₙ, P(Sₘ|Oₙ, Θ⁽ⁱ⁻¹⁾)=0. In other words, for each training session Oₙ, only the state sequences in Γₙ are possible to contribute to the update of the parameters in Equations 5-8 set forth above.

After constructing candidate state sequences, it is possible to assign the values to P⁰(sᵢ) and P⁰(sᵢ|Sⱼ) as follows. First, the whole bag of candidate state sequences Γ⁺=Γ₁+ . . . +Γ_{N} is computed, where ‘+’ denotes the bag union operation, and N is the total number of training sessions. It is then possible to assign P⁰(sᵢ)=Count(sᵢ)/|Γ⁺| and P⁰(sᵢ|Sⱼ)=Count(Sⱼo sᵢ)/Count(Sⱼ), where Count(sᵢ), Count(Sⱼ), Count(Sⱼo sᵢ) i are the numbers of the sequences in Γ⁺ that start with state sᵢ, subsequence Sⱼ, and the concatenations of Sⱼ and sᵢ, respectively. The above initialization limits the number of active parameters (i.e., the parameters updated in one iteration of the training process) to an upper bound C as indicated in the following theorem.

Theorem 1. Given training sessions X={O₁ . . . O_{N}} and the initial values assigned to parameters as described herein, the number of parameters updated in one iteration of the training of a vlHMM is at most

C=Nₛ(1+N_{sq}+Nₛᵤ)+|Γ|(T−1),

where Nₛ is the number of states, N_{sq} and Nₛᵤ are the average sizes of {P⁰(q|sᵢ)|P⁰(q|sᵢ)≠0} and {P⁰(u|sᵢ)|P⁰(u|sᵢ)≠0} over all states Sᵢ, respectively, Γ is the set of unique state sequences in Γ⁺, and T is the average length of the state sequences in Γ.

In practice, the upper bound C given by Theorem 1 is often much smaller than the size of the whole parameter space N=Nₛ (1+N_{q}+Nᵤ+Σₜ₌₂^{Tmax}Ns^{t-1}). As only one example, experimental data has shown N_{sq}=4.5<<N_{q}=1.8×10⁶, Nₛᵤ=47.8<<Nᵤ=8.3×10⁶, and |Γ|(T−1)=1.4×10⁶<<Σₜ₌₂^{Tmax}Ns^{t-1}=4.29×10³⁰.

Implementations of the initialization strategy disclosed herein also enable an efficient training process. According to Equations 5-8 set forth above, the complexity of the training algorithm is O(k N|Γₙ|), where k is the number of iterations, N is the number of training sessions, and Γₙ is the average number of candidate state sequences for a training session. In practice, Γₙ is usually small, e.g., 4.7 in some experiments. Further, although N is a very large number (e.g., 840 million in some experiments), the training sessions can be distributed on multiple computing devices, as discussed above, to make the training manageable. Empirical testing shows that the training process converges quickly, so that k may be around 10 in some examples.

### Model Application

Implementations herein apply the learned model to various search applications, such as for document re-ranking, query suggestion and URL recommendation. For example, suppose a system receives a sequence O of user events, where O consists of a sequence of queries q₁, . . . , qₜ, and for each query qᵢ(1≦i<t), the user clicks on a set of URLs Uᵢ. Initially, a set of candidate state sequences Γ_{O} are constructed as described above and the posterior probability P(Sₘ|O, Θ) is inferred for each state sequence Sₘ∉Γ_{O}, where Θ is the set of model parameters learned offline Implementations herein can derive the probability distribution of the user's current state Sₜ by P(sₜ|O,Θ)=[Σ_{Sm}∉_{Γo}P(Sₘ|O,Θ)δ(s_{m,t}=sₜ)]/[Σ_{Sm}∉_{Γo}P(Sₘ|O,Θ)], where δ(s_{m,t}=sₜ) indicates whether Sₜ is the last state of Sₘ (=1) or not (=0).

One strength of the learned model according to implementations herein is that the learned model provides a systematic approach to not only inferring the user's current state sₜ, but also predicting the user's next state sₜ₊₁. For example, P(sₜ|O,Θ)=Σ_{Sm}∉_{Γo}O(sₜ₊₁|Sₘ)P(Sₘ|O,Θ), where P(sₜ₊₁|Sₘ) is the transition probability learned offline. To keep the presentation simple, the parameter Θ is deleted from the following discussion of the model application.

Once the posterior probability distributions of P(sₜ|O) and P(sₜ₊₁|O) have been inferred, context-aware actions can be carried out, such as document re-ranking, query suggestion and URL recommendation.

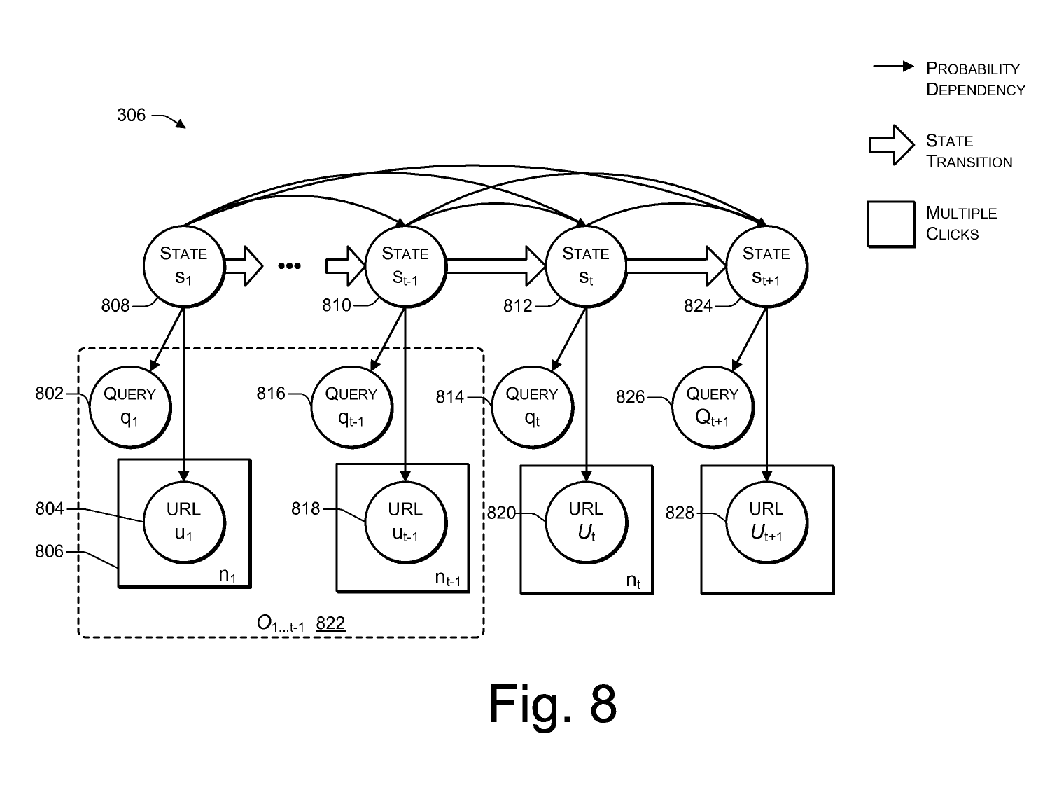

FIG. 8 illustrates a conceptual diagram of the model 306, such as a vlHMM according to some exemplary implementations herein. As discussed in detail above, sᵢ(1≦i≦t) is the hidden state which models a user's search intent at a point in time i. The user's search intent transits from sᵢ at point in time i to sᵢ₊₁ at point in time i+1. Under each search intent Sᵢ, the user raises a query qᵢ and may click a set of one or more URLs uᵢ, wherein the number of clicks is nᵢ. The search intent, state sᵢ has a probability dependency on all previous states from s₁ to sᵢ₋₁ and therefore, the queries qᵢ and clicked URLs uᵢ are observed variables, while the search intents Sᵢ are hidden variables.

FIG. 8 includes a first query q₁ 802 that may be received for entry in the model 306. A set of URLs u₁ 804 that are clicked on following the query q₁ may also be received and applied to the model 306, where n₁ 806 indicates the number of clicks. The state S₁ 808 is the hidden state which models the user's search intent at the initial point in time (e.g., 1). Similarly, the state sₜ₋₁ 810 is the hidden state which models the user's search intent at the point in time t−1, and the state Sₜ 812 is the hidden state which models the user's search intent at the current point in time t. Thus, if query qₜ 814 is the current query (i.e., the most recently raised query received as an input), then the model 306 can be used for re-ranking search results, making query suggestions, and/or suggesting URLs.

### Document Re-Ranking

According to the model of FIG. 8, the current query qₜ 814 is known, along with any prior inputs from the user, e.g., query q₁ 802, query qₜ₋₁ 816, URLs u₁ 804, and URLs uₜ₋₁ 818. Accordingly, the model can be used to re-rank the current search results Uₜ (i.e., a set of URLs Uₜ 820) returned in response to the query qₜ 814 using the posterior probability distribution P(sₜ|qₜ, O_{1 . . . t-1}), where sₜ 812 is the current search intent hidden in the user's mind and O_{1 . . . t-1} is the context 822 of the current query qₜ 814 as captured by the past queries q₁ . . . qₜ₋₁, as well as the clicks for those queries. Thus, if Sₜ={sₜ|P(sₜ|O)≠0} and Uₜ is the ranked list of URLs returned by a search engine as the answers to query qₜ, then the posterior probability P(u|O) can be computed for each URL u∉Uₜ by Σₛₜ∉_{S}P(u|sₜ)P(sₜ|O). The URLs u∉Uₜ in the search results are then re-ranked in the posterior probability descending order to obtain a re-ranked list of URLs Uₜ 820 that are ranked according to the context O_{1 . . . t-1} 822.

### Query Suggestion

Furthermore, the model 306 can be used to predict the next search intent sₜ₊₁ 824 of the user for generating query suggestions q∉Qₜ₊₁ 826 based on the posterior probability P(sₜ₊₁|qₜO_{1 . . . t-1}). For example, if Sₜ₊₁={sₜ₊₁|P(sₜ₊₁|O)≠0} and Qₜ₊₁={q|sₜ₊₁∉Sₜ₊₁, P(q|sₜ₊₁)≠0}, then, for each query q∉Qₜ₊₁, the posterior probability P(q|O)=Σsₜ₊₁∉_{St+1}P(q|sₜ₊₁)P(sₜ₊₁|O) is computed, and the top k_{q} queries with the highest probabilities are suggested, where k_{q} is a user-specified parameter to limit the number of query suggestions made.

URL Recommendation

Similarly, the model 306 can also use the predicted next search intent sₜ₊₁ 824 of the user for generating URL recommendations u∉Uₜ₊₁ 828 based on the posterior probability P(sₜ₊₁|qₜO_{1 . . . t-1}). For example, if Uₜ₊₁={u|sₜ₊₁∉Sₜ₊₁, P(u|sₜ₊₁)≠0}. For each URL u∉Uₜ₊₁, the posterior probability P(u|O)=Σₛₜ₊₁∉_{St+1}P(u|sₜ₊₁)P(sₜ₊₁|O) is computed, and the top kᵤ URLs with the highest probabilities are recommended, where kᵤ is a user-specified parameter to limit the number of URL recommendations made.

It should be noted that the probability distributions of state sₜ 812 and state sₜ₊₁ 824 are inferred from not only the current query qₜ 814, but also from the entire context O_{1 . . . t-1} 822 observed so far. For instance, if the current query qₜ 814 is just “GMC” alone, the probability of a user searching for the homepage of GMC is likely to be higher than that of searching for car review web sites. Therefore, the company homepage is ranked higher than, e.g., a website that provides automobile reviews. However, given the context O_{1 . . . t-1} 822 that a user has input a series of different car companies and clicked corresponding homepages, the probability that the user is searching for car reviews and information on a variety of cars may significantly increase, while the probability of searching for the GMC homepage specifically may decrease. Consequently, the learned model 306 will boost the car review web sites, and provide suggestions about car insurance or car pricing, instead of ranking highly websites of specific car brands.

### Exemplary Offline Process

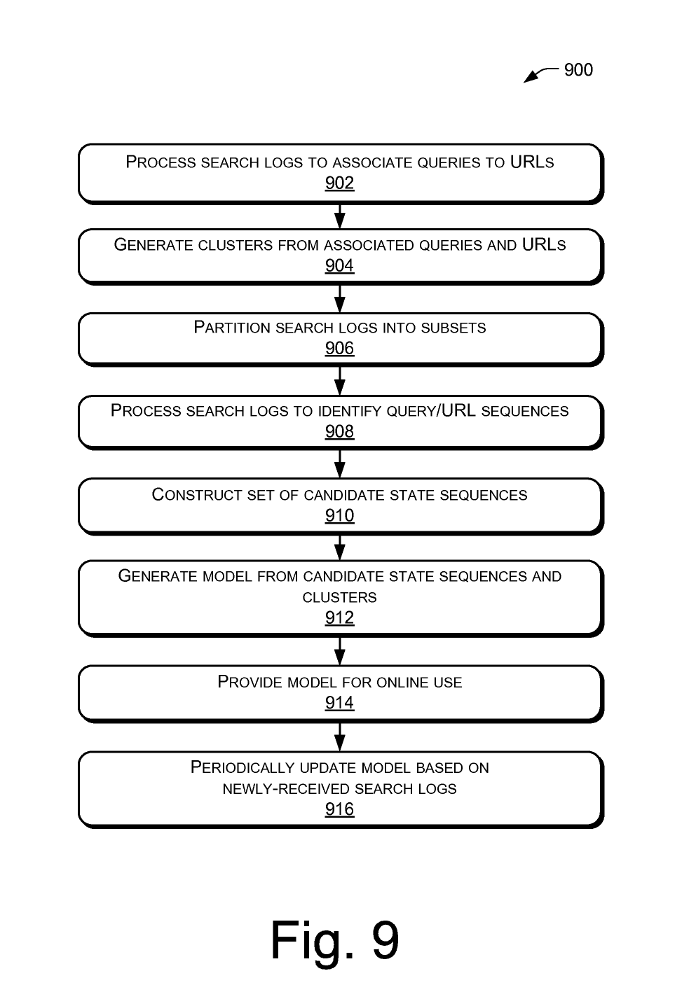

FIG. 9 illustrates a flowchart of an exemplary offline process 900 for creating a model for context aware searching. The process may be carried out by a processor of one or more computing devices executing computer program code stored as computer-readable instructions on a computer-readable storage media or the like.

At block 902, search logs are processed to associate queries with URLs in the search logs. For example, in some implementations, as discussed above, a bipartite graph may be formed for associating historical queries with the historical URLs with which they are connected, i.e., where a URL was selected in results received in response to associated query. Further, while a bipartite is described a one method for associating the queries and URLs, other implementations herein are not limited to the use of a bipartite, and other methods may alternatively be used.

At block 904, clusters are generated from the associated queries and URLs. For example, similar related queries are grouped into the same cluster. The determination of which queries are related to each other can be based on one or more predetermined parameters, e.g., a distance parameter as described above with reference to FIG. 5. Other methods of determining similarity may also be used.

At block 906, the search logs may optionally be partitioned into subsets for processing by a plurality of separate computing devices. The processing may be performed using a map-reduce distributed computing model or other suitable distributed computing model. Partitioning of the log data permits a huge amount of data to be processed, thereby enabling creation of a more accurate model.

At block 908, the search logs are processed to identify query/URL sequences from individual search sessions. For example, by extracting patterns of query sequences and/or URL sequences of individual search sessions, contexts can be derived from the sequences.

At block 910, a set of candidate sequences is constructed based on the ability of the candidate sequences to update parameters of the model. By limiting the candidate sequences, the number of active parameters of the learned model can be limited, which enables the learned model to be generated from a huge amount of raw search log data.

At block 912, the model is generated from the candidate state sequences and the clusters. The model may in some implementations be a variable length Hidden Markov Model iteratively applied based on formulas I-8 set forth above.

At block 914, the model can be provided for online use, wherein one or more received inputs are applied to the model for determining one or more search intents. For example, the model may be implemented as part of a search website for assisting users when the users conduct a search. Alternatively, the model may be incorporated into or used by a web browser of a user computing device for assisting the user.

At block 916, the model may be periodically updated using newly received search log data, so that new queries and URLs are incorporated into the model.

### Exemplary Online Process

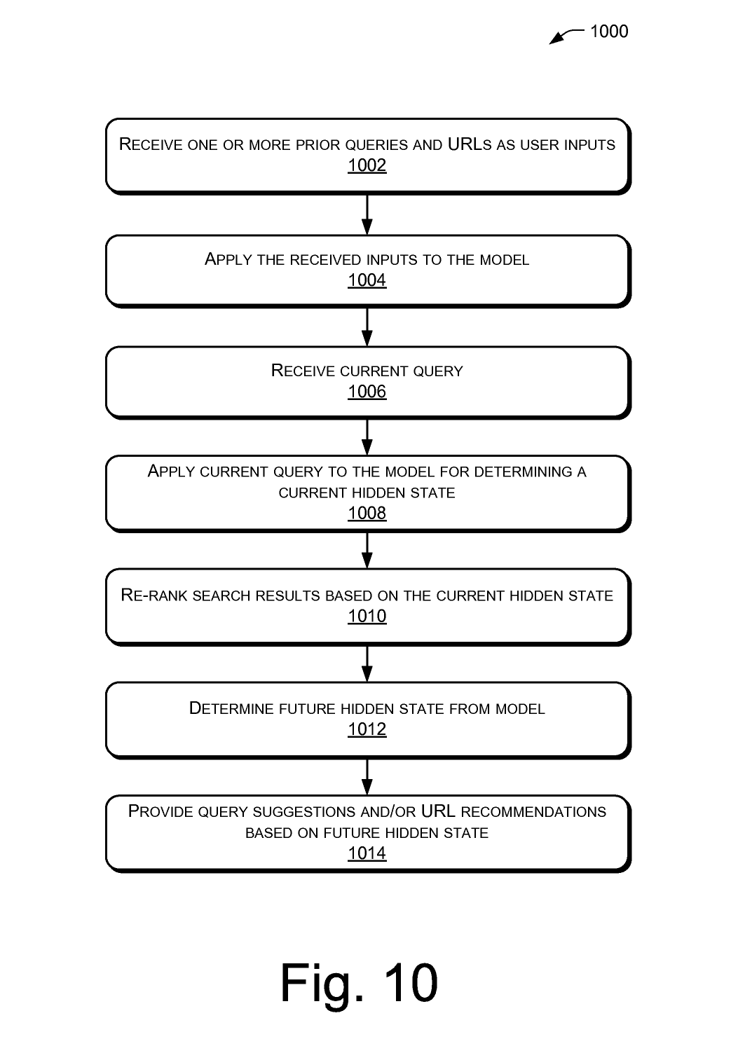

FIG. 10 illustrates a flowchart of an exemplary online process 1000 for implementing context aware searching. The process may be carried out by a processor of one or more computing devices executing computer program code stored as computer-readable instructions on a computer-readable storage media or the like.

At block 1002, optionally, one or more prior queries and any corresponding URLs selected are received as user inputs. Of course, in some implementations, just the one or more prior queries or just one or more prior URLs may be received. However, it should be noted that the more user inputs that are received, the more accurately the model is able to predict the user's search intent.

At block 1004, the one or more prior queries and URLs are applied to the model, as discussed above with reference to FIG. 8.

At block 1006, a current query qₜ is received for processing at a current point in time t.

At block 1008, the current query qₜ is applied to the model for determining a current hidden state Sₜ, as discussed above with reference to FIG. 8.

At block 1010, search results received in response to the current query may be re-ranked based on the current hidden state. For example, the search results can be re-ranked based on the posterior probability distribution P(sₜ|qₜ, O_{1 . . . t-1}).

At block 1012, a future hidden state also may be determined from the model based on the current query and the one or more prior queries and URLs.

At block 1014, one or more query suggestions and/or URL recommendations can be provided based on the future hidden state. For example, since the future hidden state corresponds to a particular cluster (Q,U), a suggested query and/or recommended URL can be derived from this cluster.

It should be noted that several issues may arise in the online application of the vlHMM as the learned model. First, users may raise new queries and click URLs which do not appear in the training data. In the i-th (1≦i≦t) round of interaction, if either a query, or a URL has not been seen by the learned model in the training data, the learned model can simply ignore the unknown queries or URLs, and still make an inference and prediction based on the remaining observations; otherwise, however, the learned model may simply skip this round (i.e., not re-ranked the results, or return any suggestions or URL recommendations). Thus, when the current query qₜ is unknown to the learned model, the learned model may take no action.

Additionally, the online application of some of the learned model implementations discussed herein may have a strong emphasis on efficiency. For example, given a user input sequence O, the major cost in applying the learned model depends on the sizes of the candidate sets Γ_{O}, Sₜ, Sₜ₊₁, Qₜ₊₁, and Uₜ₊₁. In experiments conducted by the inventors, the average numbers of Γ_{O}, Sₜ, and Sₜ₊₁ were all less than 10 and the average numbers of Qₜ₊₁ and Uₜ₊₁ were both less than 100. Moreover, the average runtime of applying the vlHMM as the learned model to one user input sequence was determined to be about 0.1 millisecond. Consequently, in cases where the sizes of candidate sets are very large or the session is extremely long, implementations herein can approximate the optimal solution by discarding the candidates with low probabilities or by truncating the session. Since implementations herein only re-rank the top URLs returned by a search engine and suggest the top queries and URLs generated by the model, such approximations will not lose much accuracy.

### Exemplary System

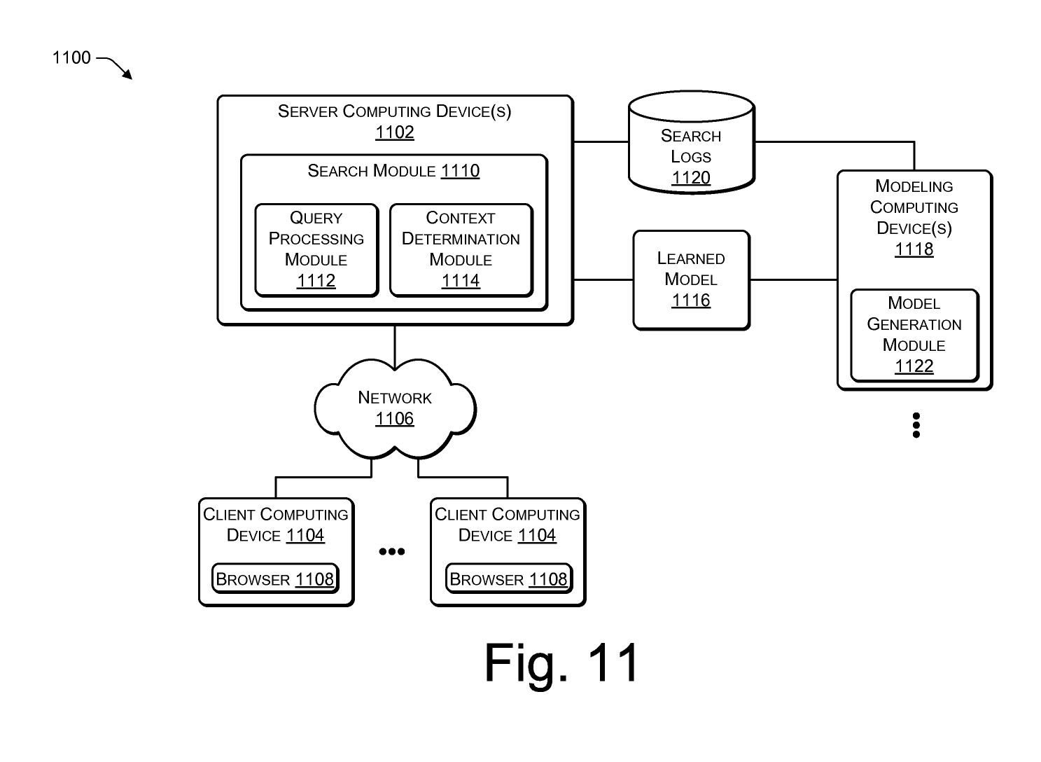

FIG. 11 illustrates an example of a system 1100 for carrying out context-aware searching according to some implementations herein. To this end, the system 1100 includes one or more server computing device(s) 1102 in communication with a plurality of client or user computing devices 1104 through a network 1106 or other communication link. In some implementations, server computing device 1102 exists as a part of a data center, server farm, or the like, and is able to serve as a component for providing a commercial search website. The system 1100 can include any number of the server computing devices 1102 in communication with any number of client computing devices 1104. For example, in one implementation, network 1106 includes the World Wide Web implemented on the Internet, including numerous databases, servers, personal computers (PCs), workstations, terminals, mobile devices and other computing devices spread throughout the world and able to communicate with one another. Alternatively, in another possible implementation, the network 1106 can include just a single server computing device 1102 in communication with one or more client devices 1104 via a LAN (local area network) or a WAN (wide area network). Thus, the client computing devices 1104 can be coupled to the server computing device 1102 in various combinations through a wired and/or wireless network 1106, including a LAN, WAN, or any other networking technology known in the art using one or more protocols, for example, a transmission control protocol running over Internet protocol (TCP/IP), or other suitable protocols.

In some implementations, client computing devices 1104 are personal computers, workstations, terminals, mobile computing devices, PDAs (personal digital assistants), cell phones, smartphones, laptops or other computing devices having data processing capability. Furthermore, client computing devices 1104 may include a browser 1108 for communicating with server computing device 1102, such as for submitting a search query, as is known in the art. Browser 1108 may be any suitable type of web browser such as Internet Explorer®, Firefox®, Chrome®, Safari®, or other type of software that enables submission of a query for a search.

In addition, server computing device 1102 may include a search module 1110 for responding to search queries received from client computing devices 1104. Accordingly, search module 1110 may include a query processing module 1112 and a context determination module 1114 according to implementations herein, for providing an improved search experience such as by providing query suggestions, URL recommendations, and/or search result re-ranking. As discussed above, context determination module 1114 uses a learned model 1116, which may be part of context determination module 1114, or which may be a separate module. In some implementations, learned model 1116 may be generated offline by one or more modeling computing devices 1118 using search logs 1120, which contain the historical search log information. For example, modeling computing device(s) 1118 may be part of a data center containing server computing device 1102, or may be in communication with server computing device 1102 by network 1106 or through other connection. In some implementations, modeling computing devices 1118 may include a model generation module 1122 for generating the learned model 1116. Model generation module 1122 may also be configured to continually update learned model 1116 through receipt of newly received search logs, such as from server computing device(s) 1102. Additionally, in other implementations, a server computing device 1102 may also serve the function of generating the learned model 1116 from search logs 1120, and may have model generation module 1122 incorporated therein for generating the learned model, rather than having one or more separate modeling computing devices 1118.

Furthermore, while a particular exemplary system architecture is illustrated in FIG. 11, it should be understood that other suitable architectures may also be used, and that implementations herein are not limited to any particular architecture. For example, in other implementations, context determination module 1114 may be located in client computing devices 1104 as part of browser 1108. In such an implementation, client computing device 1104 can determine the context of the user's search and provide query suggestions, URL recommendations, result re-ranking, or the like, through the browser 1108, or as part of a separate module. Other variations will also be apparent to those of skill in the art in light of the disclosure herein.

### Server Computing Device

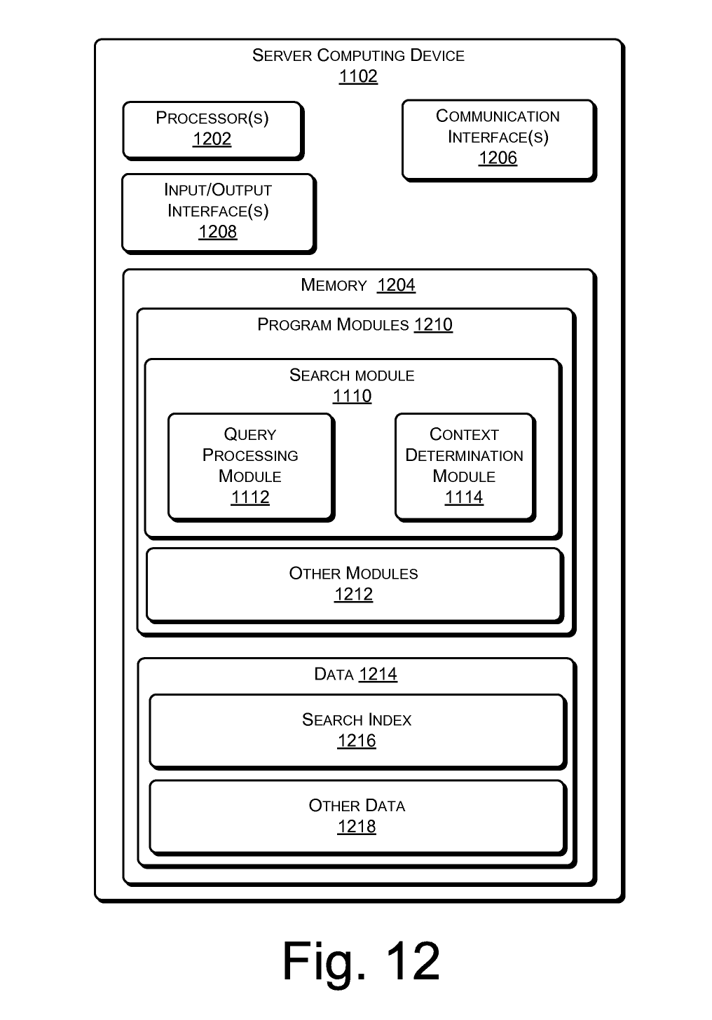

FIG. 12 illustrates an example of a server computing device 1202 configured to implement context aware searching according to some implementations. In the illustrated example, server computing device 1102 includes one or more processors 1202 coupled to a memory 1204, one or more communication interfaces 1206, and one or more input/output interfaces 1208. The processor(s) 1202 can be a single processing unit or a number of processing units, all of which may include multiple computing units or multiple cores. The processor(s) 1202 may be implemented as one or more microprocessors, microcomputers, microcontrollers, digital signal processors, central processing units, state machines, logic circuitries, and/or any devices that manipulate signals based on operational instructions. Among other capabilities, the processor(s) 1202 can be configured to fetch and execute computer-readable instructions stored in the memory 1204 or other computer-readable storage media.

The memory 1204 can include any computer-readable storage media known in the art including, for example, volatile memory (e.g., RAM) and/or non-volatile memory (e.g., flash, etc.), mass storage devices, such as hard disk drives, solid state drives, removable media, including external drives, removable drives, floppy disks, optical disks, or the like, or any combination thereof. The memory 1204 stores computer-readable processor-executable program instructions as computer program code that can be executed by the processor(s) 1202 as a particular machine for carrying out the methods and functions described in the implementations herein.

The communication interface(s) 1206 facilitate communication between the server computing device 1102 and the client computing devices 1104 and/or modeling computing device 1118. Furthermore, the communication interface(s) 1206 may include one or more ports for connecting a number of client-computing devices 1104 to the server computing device 1102. The communication interface(s) 1206 can facilitate communications within a wide variety of networks and protocol types, including wired networks (e.g., LAN, cable, etc.) and wireless networks (e.g., WLAN, cellular, satellite, etc.), the Internet and the like. In one implementation, the server computing device 1102 can receive an input search query from a user or client device via the communication interface(s) 1206, and the server computing device 1102 can send search results and context aware information back to the client computing device 1104 via the communication interface(s) 1206.

Memory 1204 includes a plurality of program modules 1210 stored therein and executable by processor(s) 1202 for carrying out implementations herein. Program modules 1210 include the search module 1110, including the query processing module 1112 and the context determination module 1114, as discussed above. Memory 1204 may also include other modules 1212, such as an operating system, communication software, drivers, a search engine or the like.

Memory 1204 also includes data 1214 that may include a search index 1216 and other data 1218. In some implementations, server computing device 1102 receives a search query from a user or an application, and processor(s) 1202 executes the search query using the query processing module 1112 to access the search index 1216 to retrieve relevant search results. Processor(s) 1202 can also execute the context determination module 1114 for determining a context of the search and providing query suggestions, URL recommendations, result re-ranking, and the like. Further, while exemplary system architectures have been described, it will be appreciated that other implementations are not limited to the particular system architectures described herein.

### Exemplary Computing Implementations

Context determination module 1110 and model generation module 1122, described above, can be employed in many different environments and situations for conducting searching, context determination, and the like. Generally, any of the functions described with reference to the figures can be implemented using software, hardware (e.g., fixed logic circuitry), manual processing, or a combination of these implementations. The term “logic, “module” or “functionality” as used herein generally represents software, hardware, or a combination of software and hardware that can be configured to implement prescribed functions. For instance, in the case of a software implementation, the term “logic,” “module,” or “functionality” can represent program code (and/or declarative-type instructions) that performs specified tasks when executed on a processing device or devices (e.g., CPUs or processors). The program code can be stored in one or more computer readable memory devices or other computer readable storage devices. Thus, the methods and modules described herein may be implemented by a computer program product. The computer program product may include computer-readable media having a computer-readable program code embodied therein. The computer-readable program code may be adapted to be executed by one or more processors to implement the methods and/or modules of the implementations described herein. The terms “computer-readable storage media”, “processor-accessible storage media”, or the like, refer to any kind of machine storage medium for retaining information, including the various kinds of storage devices discussed above.

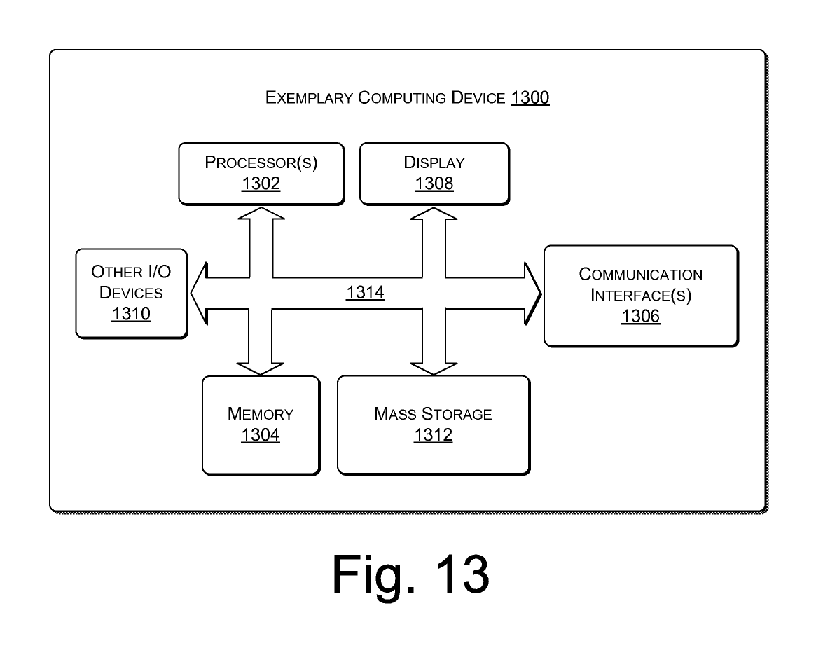

FIG. 13 illustrates an exemplary configuration of computing device implementation 1300 that can be used to implement the devices or modules described herein, such as any of server computing device 1102, client computing devices 1104, and/or modeling computing devices 1118. The computing device 1300 may include one or more processors 1302, a memory 1304, communication interfaces 1306, a display 1308, other input/output (I/O) devices 1310, and one or more mass storage devices 1312 in communication via a system bus 1314. Memory 1304 and mass storage 1312 are examples of the computer-readable storage media described above for storing instructions which are executed by the processor(s) 1302 to perform the various functions described above. For example, memory 1304 may generally include both volatile memory and non-volatile memory (e.g., RAM, ROM, or the like). Further, mass storage media 1306 may generally include hard disk drives, solid-state drives, removable media, including external and removable drives, memory cards, Flash memory, floppy disks, optical disks (e.g., CD, DVD), or the like. Both memory 1304 and mass storage 1312 may be collectively referred to as memory or computer-readable media herein.

The computing device 1300 can also include one or more communication interfaces 1306 for exchanging data with other devices, such as via a network, direct connection, or the like, as discussed above. A display 1308 may be included as a specific output device for displaying information, such as for displaying results of the searches described herein to a user, including the query suggestions, URL recommendations, re-ranked results, and the like. Other I/O devices 1310 may be devices that receive various inputs from the user and provide various outputs to the user, and can include a keyboard, a mouse, printer, audio input/output devices, and so forth.

The computing device 1300 described herein is only one example of a computing environment and is not intended to suggest any limitation as to the scope of use or functionality of the computer and network architectures that can implement context aware searching. Neither should the computing device 1300 be interpreted as having any dependency or requirement relating to any one or combination of components illustrated in the computing device implementation 1300. In some implementations, computing device 1300 can be, for example, server computing device 1102, client computing device 1104, and/or modeling computing device 1118.

In addition, implementations herein are not necessarily limited to any particular programming language. It will be appreciated that a variety of programming languages may be used to implement the teachings described herein. Further, it should be noted that the system configurations illustrated in FIGS. 11, 12 and 13 are purely exemplary of systems in which the implementations may be provided, and the implementations are not limited to the particular hardware configurations illustrated.

Furthermore, it may be seen that this detailed description provides various exemplary implementations, as described and as illustrated in the drawings. This disclosure is not limited to the implementations described and illustrated herein, but can extend to other implementations, as would be known or as would become known to those skilled in the art. Reference in the specification to “one implementation”, “this implementation”, “these implementations” or “some implementations” means that a particular feature, structure, or characteristic described in connection with the implementations is included in at least one implementation, and the appearances of these phrases in various places in the specification are not necessarily all referring to the same implementation. Additionally, in the description, numerous specific details are set forth in order to provide a thorough disclosure. However, it will be apparent to one of ordinary skill in the art that these specific details may not all be needed in all implementations. In other circumstances, well-known structures, materials, circuits, processes and interfaces have not been described in detail, and/or illustrated in block diagram form, so as to not unnecessarily obscure the disclosure.

### Conclusion

Implementations described herein provide for context-aware search by learning a learned model from search sessions extracted from search log data. Implementations herein also tackle the challenges of learning a large model with millions of states from hundreds of millions of search sessions by developing a strategy for parameter initialization which can greatly reduce the number of parameters to be estimated in practice Implementations herein also devise a method for distributed model learning Implementations of the context-aware approach described herein have shown to be both effective and efficient.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims Additionally, those of ordinary skill in the art appreciate that any arrangement that is calculated to achieve the same purpose may be substituted for the specific implementations disclosed. This disclosure is intended to cover any and all adaptations or variations of the disclosed implementations, and it is to be understood that the terms used in the following claims should not be construed to limit this patent to the specific implementations disclosed in the specification. Instead, the scope of this patent is to be determined entirely by the following claims, along with the full range of equivalents to which such claims are entitled.

1. A method implemented on one or more computing devices, the method comprising:
accessing historical search data including a plurality of queries and a plurality of Uniform Resource Locators (URLs);
associating at least some of the queries with one or more URLs of the plurality of URLs, wherein a particular query is associated with a particular URL when the particular URL was selected as a result of the particular query during a search session;
creating a plurality of query clusters from the associated queries and URLs, wherein, a query cluster includes queries determined to be related to each other according to a predetermined parameter;
extracting a plurality of query/URL sequences of search sessions from the historical data, wherein each query/URL sequence includes a sequence of one or more queries and zero or more associated URLs obtained from an individual search session;
generating a model having hidden states based on the query clusters and the plurality of query/URL sequences;
applying, by a processor of one of the computing devices, a current query to the model; and
determining a current hidden state from the model based on the current query, wherein the current hidden state represents an inferred current search intent of the current query.

2. The method according to claim 1, wherein the model is a Hidden Markov Model generated by conducting a limited number of random walks through the associated queries and URLs.

3. The method according to claim 1, further comprising:
receiving a plurality of prior queries and one or more prior URLs prior to receiving the current query; and
applying the model to the current query includes applying the plurality of prior queries and the one or more prior URLs when applying the model to the current query to determine the current search intent of the current query, wherein the model infers the current search intent of the current query based on a context derived from the prior queries and the one or more prior URLs.

4. The method according to claim 3, further comprising:
receiving search results in response to the current query; and
re-ranking the search results received using a posterior probability distribution determined from the model based on the current query and the context derived from the prior queries and one or more prior URLs.

5. The method according to claim 3, wherein applying the current query to the model further comprises predicting a next search intent based on the current query and the context derived from the prior queries and the one or more prior URLs for at least one of suggesting a next query or making a URL recommendation.

6. The method according to claim 5, wherein the next query is obtained from a cluster of queries corresponding to the next search intent.

7. A method comprising:
accessing search data including a plurality of queries and a plurality of Uniform Resource Locators (URLs);
extracting a plurality of sequences of search sessions from the search data, wherein each sequence includes a sequence of one or more queries and zero or more associated URLs obtained from an individual search session;
generating, by a processor, a model having hidden states based on the plurality of sequences;
applying the model to a received query for predicting a context of the received query.

8. The method according to claim 7, wherein the model is a Hidden Markov Model configured to predict the hidden state based on the received query and one or more prior queries from a same search session as the received query.

9. The method according to claim 8, further comprising:
prior to generating the model, associating at least some of the queries of the search data with one or more URLs of the plurality of URLs, wherein a particular query is associated with a particular URL when the particular URL was selected as a result of the particular query during a search session;
creating a plurality of clusters from the associated queries and URLs,
wherein, a cluster includes queries from the search data determined to be similar,
wherein the generating the model is based on the clusters and the plurality of sequences.

10. The method according to claim 9, further comprising generating the model by conducting one or more random walks through the associated queries and URLs, wherein the random walks are applied up to a predetermined restricted number of steps.

11. The method according to claim 9,
wherein the search data is partitioned into subsets and distributed to a plurality of computing devices for processing using a map-reduce distributed computing paradigm,
wherein during a map stage, posterior probabilities are inferred for identified search sessions for generating key/value pairs,
wherein during a reduce stage, the computing devices use the generated key/value pairs to derive probabilities of parameters to be applied during generation of the model.

12. The method according to claim 9,
wherein weights are assigned to the associations between the queries and URLs from the search data,
wherein, the weights represent a number of times that a URL was selected as a results of an associated query,
wherein during creating the plurality of clusters, queries and URLs having associations with low weights are not included in the clusters.

13. The method according to claim 7, wherein applying the model to a received query for predicting a context of the received query further comprises:
determining a current hidden state of the received query for re-ranking current search results; and
determining a future hidden state corresponding to the received query for providing a suggested or a recommended URL.

14. Computer-readable storage media containing processor-executable instructions to be executed by a processor for carrying out the method according to claim 7.

15. A computing device comprising:
a processor coupled to computer-readable storage media containing instructions executable by the processor to implement:
a query processing module for receiving a current query;
a context determination module that applies the current query to a model to determine a hidden state indicative of the context of the current query.

16. The computing device according to claim 15,
wherein the model is a variable length Hidden Markov Model that receives the current query and one or more prior queries from a same search session as the current query for predicting the hidden state.

17. The computing device according to claim 15, wherein the hidden state is a future hidden state corresponding to a cluster of similar queries, wherein one or more queries from the cluster of similar queries is provided as a suggested query.

18. The computing device according to claim 17, further comprising a cluster of URLs associated with the cluster of similar queries, wherein one or more URLs from the cluster of URLs is provided as a recommended URL.

19. The computing device according to claim 15,
wherein the computing device is in communication with a plurality of modeling computing devices that generate the model using historical search log data,
wherein the historical search log data is partitioned into subsets for distributed processing by the plurality of modeling computing devices.

20. The computing device according to claim 15, wherein the computing device is a client computing device having a web browser that comprises the context determination module.
